(19) United States
(12) Patent Application Publication
(10) Pub. No.: US 2015/0149346 A1
(43) Pub. Date: May 28, 2015

(54) SYSTEMS AND METHODS FOR SUPPORTING CHARITABLE CONTRIBUTIONS

(71) Applicant: Goods Exchange, Los Altos, CA (US)

(72) Inventors: Nirmit Parikh, San Jose, CA (US); Osman Rashid, Los Altos, CA (US); Babur Habib, New York, NY (US)

(73) Assignee: GOODS EXCHANGE, Los Altos, CA (US)

(21) Appl. No.: 14/289,439

(22) Filed: May 28, 2014

Related U.S. Application Data
(60) Provisional application No. 61/909,999, filed on Nov. 27, 2013.

(51) Int. Cl. G06Q 30/02; G06Q 20/10

(52) U.S. Cl. CPC G06Q 30/0279; G06Q 20/10
USPC 705/39; 705/329

(57) ABSTRACT

A method may include receiving a notification of a charitable action by an actor. In the method, a goodness magnitude of the charitable action is measured, the goodness magnitude providing a quantified moral value of the charitable action. The actor is assigned an amount of exchangeable currency, the amount being based on the measured goodness magnitude, the assigning being for the charitable action.

### CLAIM OF PRIORITY

The present application claims priority to U.S. Ser. No. 61/909,999, filed Nov. 27, 2013, and entitled “Supporting Charitable Contributions,” the contents of which is hereby incorporated by reference herein.

### TECHNICAL FIELD

The technical field relates to computer systems and methods. More particularly, the technical field relates to computer systems and methods for facilitating electronic transactions and computer systems and methods maintaining electronic currencies.

### BACKGROUND

Charitable actions have played an important role in human history. Since ancient times, many cultures, religions, and civilizations have emphasized the desirable effects of performing charity to those in need. In more modern times, people perform charity on many levels. For example, some people give money, while others give non-monetary things, such as time, assistance, food, clothing, shelter, moral support, blood, or myriad other things. As another example, some people perform charity periodically while others do so irregularly or only once. People also perform charity for various reasons. For instance, some entities perform charity out of the goodness of their hearts or for the pure satisfaction of helping others. Other entities, however, perform charity for a variety of reasons that appear self-interested, such as for tax deductions or to build goodwill in a community they are a part of Irrespective of a person's levels or reasons for performing charity, the charitable actions performed by various entities form an important part of many modern societies and modern economies.

Unfortunately, there is often a disconnection between the different types of charities performed at a given time. Philanthropic efforts performed to get tax deductions or build community goodwill are often not connected to the acts of charity people perform. These disconnections often make it financially difficult to reward people who perform acts of charity.

### SUMMARY

A method may include receiving a notification of a charitable action by an actor. In the method, a goodness magnitude of the charitable action is measured, the goodness magnitude providing a quantified moral value of the charitable action. The actor is assigned an amount of exchangeable currency, the amount being based on the measured goodness magnitude, the assigning being for the charitable action.

In some implementations, the exchangeable currency is digital signed. In some implementations, the exchangeable currency is infinitely divisible. In various implementations, the exchangeable currency is divisible up to a fundamental level. In specific implementations, the exchangeable currency is fungible with other exchangeable currency assigned for other charitable actions. In additional implementations, the exchangeable currency is characterized by transactional irreversibility for all transactions involving the exchangeable currency.

In various implementations, the exchangeable currency is backed at least in part by a donation from a donor. The goodness magnitude may be based on one or more of: a relationship between the actor and a beneficiary of the charitable action, a burden the charitable action places on the actor, and other factors.

In some implementations, the method further comprises: maintaining a reserve of the exchangeable currency; and providing the amount from the reserve. In an implementation, the charitable action is entered into a desktop/mobile application by a user. In various implementations, the charitable action is entered into a desktop/mobile application by a third party other than the actor.

In some implementations, facilitating exchange by the actor comprises: receiving a request from a redeemer to redeem the exchangeable currency; and fulfilling the request with at least a portion of the assigned exchangeable currency. The redeemer may comprise a peer of the actor. The method may further comprise computing a present valuation of the amount of exchangeable currency, and fulfilling the request using the present valuation. In some implementations, the present valuation is computed at the time of receiving the request from the redeemer. In various implementations, the present valuation is based at least in part on a total circulating amount of the exchangeable currency. In some implementations, the present valuation is based at least in part on a total reserve amount of the exchangeable currency. In various implementations, exchange by the actor of the exchangeable currency is facilitated.

A system may include: a charitable action recording engine; a goodness magnitude measurement engine coupled to the charitable action recording engine; a good currency assignment engine coupled to the goodness magnitude measurement engine; and a good currency redemption engine coupled to the good currency assignment engine. In operation, the charitable action recording engine receives a notification of a charitable action by an actor; the goodness magnitude measurement engine measures a goodness magnitude of the charitable action, the goodness magnitude providing a quantified moral value of the charitable action; the good currency assignment engine assigns the actor an amount of exchangeable currency, the amount being based on the measured goodness magnitude, the assigning being for the charitable action; and the good currency redemption engine facilitates exchange by the actor of the exchangeable currency.

A system may comprise: means for receiving a notification of a charitable action by an actor; means for measuring a goodness magnitude of the charitable action, the goodness magnitude providing a quantified moral value of the charitable action; means for assigning the actor an amount of exchangeable currency, the amount being based on the measured goodness magnitude, the assigning being for the charitable action; and means for facilitating exchange by the actor of the exchangeable currency.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram illustrating an example of a good currency exchange environment, in accordance with some implementations.

FIG. 2 depicts a flowchart of an example of a method for facilitating exchange of good currency, in accordance with some implementations.

FIG. 3 depicts a diagram illustrating an example of a good currency management engine, in accordance with some implementations.

FIG. 4 depicts a diagram illustrating an example of a good currency assignment engine, in accordance with some implementations.

FIG. 5 depicts a flowchart of an example of a method for assigning good currency for a good deed, in accordance with some implementations.

FIG. 6 depicts a diagram illustrating an example of a goodness measurement management engine, in accordance with some implementations.

FIG. 7 depicts a flowchart of an example of a method for measuring a goodness magnitude of a good deed, in accordance with some implementations.

FIG. 8 depicts a screen of an example of implementing a goodness magnitude calculation, in accordance with some implementations.

FIG. 9 depicts a screen of an example of a goodness magnitude calculation, in accordance with some implementations.

FIG. 10 depicts a diagram illustrating an example of a good currency circulation management engine, in accordance with some implementations.

FIG. 11 depicts a flowchart of an example of a method for creating good currency based on a donation, in accordance with some implementations.

FIG. 12 depicts a flowchart of an example of a method for assigning good currency for a good deed, in accordance with some implementations.

FIG. 13 depicts an example of a screen of maintaining a goodness reserve, in accordance with some implementations.

FIG. 14 depicts an example of a screen for assigning good currency for a good deed, in accordance with some implementations.

FIG. 15 depicts an example of a screen for assigning good currency for a good deed, in accordance with some implementations.

FIG. 16 depicts an example of a screen for redeeming good currency, in accordance with some implementations.

FIG. 17 depicts an example of a screen for redeeming good currency, in accordance with some implementations.

FIG. 18 depicts an example of a screen for redeeming good currency, in accordance with some implementations.

FIG. 19 depicts an example of a screen for redeeming good currency, in accordance with some implementations.

FIG. 20 depicts an example of a screen for generating a charitable actions report, in accordance with some implementations.

FIG. 21 depicts an example of a screen showing an actor's good currency redemption history, in accordance with some implementations.

FIG. 22 depicts an example of a screen for valuing good currency, in accordance with some implementations.

FIG. 23 depicts an example of a computer system, in accordance with some implementations.

FIG. 24 depicts an example of an actor interface engine, in accordance with some implementations.

### DETAILED DESCRIPTION OF THE DRAWINGS

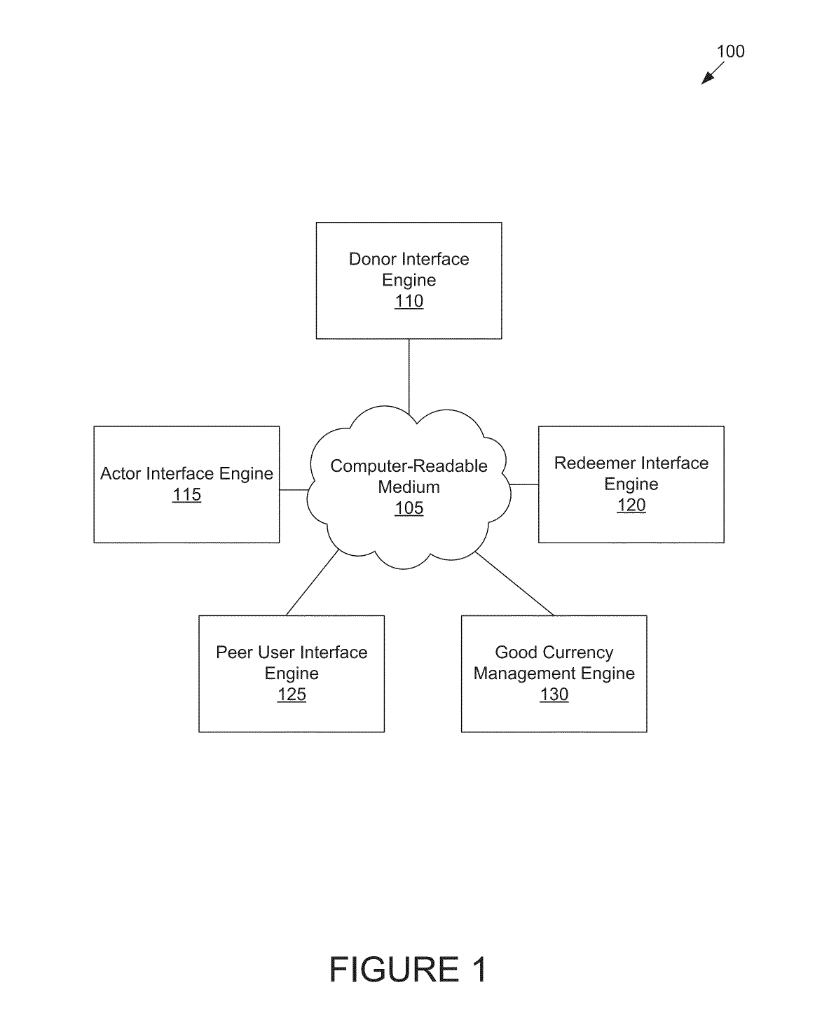

FIG. 1 depicts a diagram illustrating an example of a good currency exchange environment 100, in accordance with some implementations. In the example of FIG. 1, the good currency exchange environment 100 includes a computer-readable medium 105, a donor interface engine 110, an actor interface engine 115, a redeemer interface engine 120, a peer user interface engine 125, and a good currency management engine 130. In various implementations, the good currency exchange environment 100 receives donations from donors, uses the donations to back a fixed amount of “good currency.” That fixed amount of good currency is placed in a reserve. The good currency exchange environment 100 further allows actors to exchange amounts of good currency in circulation for products and services from other actors and from redeemers. In an implementation, exchanges of good currency are governed by a real-time valuation of the good currency. More specifically, in an implementation, the exchanges of good currency are governed by a computation of supply of good currency and demand for good currency at the time of a particular redemption.

As a matter of lexicography, the term “donor,” as used in this paper, may refer to an entity that provides a donation to the good currency exchange environment 100. The donation may be in any known or convenient format, such as cash, tangible or real property, a portion of a line of credit, or any item having a monetary value. The word “actor,” as used in this paper, may refer to entities performing charitable actions. The word “peer,” used in this paper, may refer to entities that exchange good currency but need not perform charitable actions. The word “redeemer,” as used in this paper, may refer to entities that accept good currency for at least a portion of products, at least a portion of services, or provide other benefits for good currency. A redeemer may or may not be a peer of an actor. The phrase “charitable action,” as used in this paper, may include at least actions performed for the benefit of persons, places, or things other than an actor. The phrase “charitable action” may be used to signify, more generally, good deeds performed by actors. Examples of charitable actions include giving blood, planting trees, giving money to others, giving food to others, making a donation to a cause, etc. Though charitable actions need not be distinguished from “donations,” it is noted that in various implementations, “donations” may be of a larger scale than “charitable actions.”

The phrase “good currency,” as used in this paper, may refer to electronic currency representative of charitable actions performed by actors and backed by the donations of donors. Good currency may have one or more particular attributes. For instance, in some implementations, all items of good currency may be digitally signed. Good currency may also be fungible, meaning it may be freely exchangeable and/or redeemable with other good currency. In some implementations, good currency may be infinitely divisible. For instance, an item of good currency may be infinitely partitioned into smaller portions. In various implementations, good currency may be divisible up to a fundamental point, such as a fundamental particle of good currency. In an implementation, good currency may be characterized by transactional irreversibility. For instance, in this implementation, once a transaction using good currency has occurred, the participants to the transaction may not be allowed to reverse the transaction. In some implementations, good currency can be encrypted for secure transactions. In some implementations, good currency may be printed on bills (e.g., as paper or cloth currency). In these implementations, the bills may contain a unique identifier (e.g., a Quick Response (QR) Code) that identifies the bill within the context of the good currency exchange environment 100.

In the example of FIG. 1, the computer-readable medium 105 is coupled to the donor interface engine 110, the actor interface engine 115, the redeemer interface engine 120, the peer user interface engine 125, and the good currency management engine 130. In a specific implementation, the computer-readable medium 105 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 105 broadly includes, as understood from relevant context, anything from a minimalist coupling of the components illustrated in the example of FIG. 1, to every component of the Internet and networks coupled to the Internet. In some implementations, the computer-readable medium 105 is administered by a service provider, such as an Internet Service Provider (ISP).

In various implementations, the computer-readable medium 105 may include technologies such as Ethernet, 802.11, worldwide interoperability for microwave access (WiMAX), 3G, 4G, CDMA, GSM, LTE, digital subscriber line (DSL), etc. The computer-readable medium 105 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over computer-readable medium 105 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the computer-readable medium 105 includes a wired network using wires for at least some communications. In some implementations, the computer-readable medium 105 comprises a wireless network. A “wireless network,” as used in this paper may include any computer network communicating at least in part without the use of electrical wires. In various implementations, the computer-readable medium 105 includes technologies such as Ethernet, 802.11, worldwide interoperability for microwave access (WiMAX), 3G, 4G, CDMA, GSM, LTE, digital subscriber line (DSL), etc. The computer-readable medium 105 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer-readable medium 105 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the computer-readable medium 105 is compatible with the 802.11 protocols specified by the Institute of Electrical and Electronics Engineers (IEEE). In a specific implementation, the wireless network of the computer-readable medium 105 is compatible with the 802.3 protocols specified by the IEEE. In some implementations, IEEE 802.3 compatible protocols of the computer-readable medium 105 may include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the computer-readable medium 105.

In the example of FIG. 1, the donor interface engine 110 is coupled to the computer-readable medium 105. The donor interface engine 110 may include an “engine” and a “datastore” as described in this paper. An engine, as used in this paper, includes a dedicated or shared processor and, typically, firmware or software modules executed by the processor. Depending upon implementation-specific or other considerations, an engine can be centralized or its functionality distributed. An engine can include special purpose hardware, firmware, or software embodied in a computer-readable medium for execution by the processor.

A datastore, as used in this paper, can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper. Datastores can include data structures. As used in this paper, a data structure is associated with a particular way of storing and organizing data in a computer so it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures for creating and manipulating instances of that structure.

In a specific implementation, the donor interface engine 110 interfaces with donors. The donor interface engine 110 may include a standalone application for a computer or a mobile application for a mobile device. In some implementations, the donor interface engine 110 may be implemented as a web portal or a part of a web page displayed on a donor's device. The donor interface engine 110 may receive donations from donors. That is, in an implementation, the donor interface engine 110 may receive actual sources of donations (e.g., cash, tangible or real property, a portion of a line of credit, or any item having a monetary value, etc.). In some implementations, the donor interface engine 110 receives with other financial applications used by a donor. For instance, the donor interface engine 110 may, in various implementations, interface with a donor's bank applications, mutual fund applications, or asset transfer applications to receive donations. In an implementation, the donor interface engine 110 provides donations to the good currency management engine 130 through the computer-readable medium 105.

In the example of FIG. 1, the actor interface engine 115 is coupled to the computer-readable medium 105. The actor interface engine 115 may include an “engine” and a “datastore,” as described in this paper. In a specific implementation, the actor interface engine 115 interfaces with actors. The actor interface engine 115 may include a standalone application for a computer, a mobile application for a mobile device, or may be implemented as a web portal or a part of a web page displayed on an actor's device. The actor interface engine 115 may be incorporated into one or more devices associated with the actor, including without limitation: an actor's mobile phone, devices associated with the actor, wearable devices that identify the actor, etc. In a specific implementation, the actor interface engine 115 may be managed by the good currency management engine 130 as discussed further in this paper, though it is noted that one or more of the functionalities described herein may be incorporated in the actor interface engine 115 itself.

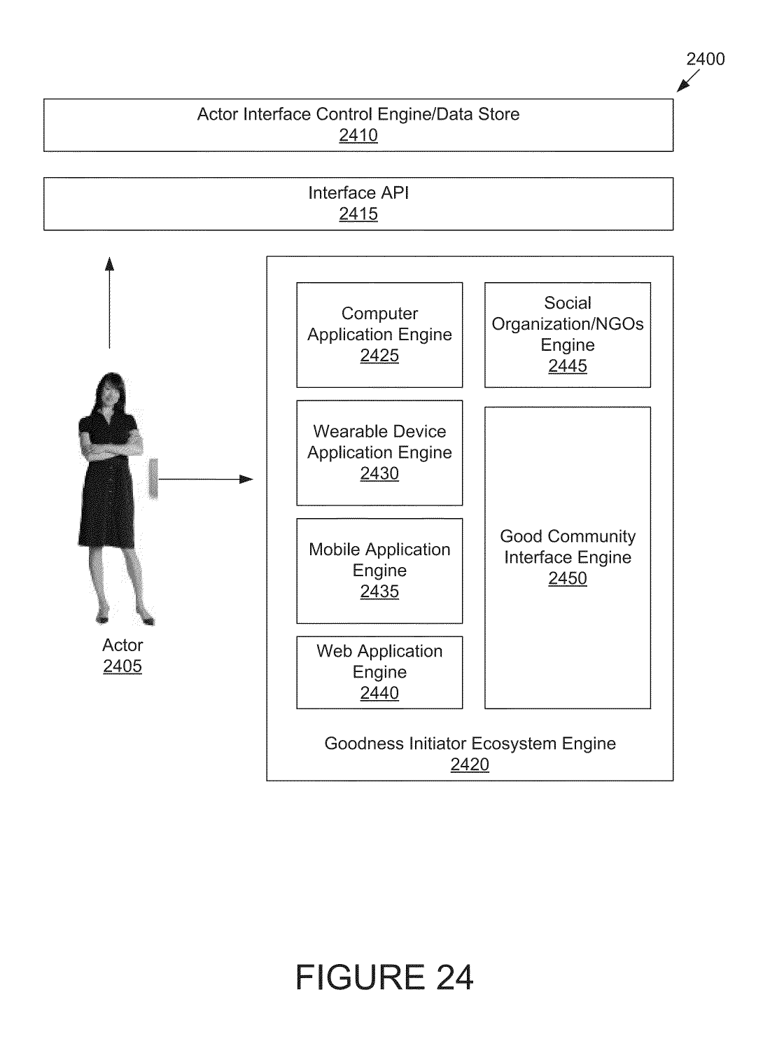

In an implementation, the actor interface engine 115 receives notifications of charitable actions performed by an actor. More specifically, the actor interface engine 115 may chronicle charitable actions performed by the actor. In some implementations, the actor interface engine 115 may manually receive notifications of the charitable actions from the actor itself. That is, the actor interface engine 115 may provide user interface elements (e.g., text boxes, radio buttons, etc.) for actors to manually input charitable actions they have performed. In various embodiments, the actor interface engine 115 may automatically receive the notifications of charitable actions from third parties other than the actor. That is, in various embodiments, the actor interface engine 115 may be automatically populated with information about charitable actions from third parties, such as charitable organizations. In these embodiments, the third party notifications of an actor's charitable actions may be seen as easier to verify than embodiments where the actor has to manually input its own charitable actions. In an implementation, the actor interface engine 115 exposes application programming interfaces (APIs) to the applications or websites of charitable organizations. The notifications of charitable actions, in this implementation, may come through the APIs. For example, in some implementations, the actor interface engine 115 may have a form similar to an actor interface engine 2400, shown in FIG. 24.

FIG. 24 shows an example of an actor interface engine 2400, in accordance with some implementations. The actor interface engine 2400 includes an actor interface control engine/datastore 2410, an interface API 2415, and a goodness initiator ecosystem engine 2420. An actor 2405 may interface with one or more of the actor interface control engine/datastore 2410, the interface API 2415, and the goodness initiator ecosystem engine 2420. The goodness initiator ecosystem engine 2420 may include a computer application engine 2425, a wearable device application engine 2430, a mobile application engine 2435, a web application engine 2440, a social organization/NGOs engine 2445, and a good community interface engine 2450. The computer application engine 2425 may control computer applications on the goodness initiator ecosystem engine 2420. The wearable device application engine 2430 may control applications associated with wearable devices. The mobile application engine 2435 may control mobile applications on the goodness initiator ecosystem engine 2420. The web application engine 2440 may control web applications on the goodness initiator ecosystem engine 2420. The social organization/NGOs engine 2445 may interface with social organization/NGOs. The good community interface engine 2450 may interface with other aspects of a good currency exchange environment, as discussed herein.

In an implementation, the actor interface engine 115 allows an actor to manage good currency associated with the actor's charitable actions. More specifically, the actor interface engine 115 allows the actor to receive good currency for the actor's charitable actions. The actor interface engine 115 allows allow the actor to trade good currency with others, including the actor's peers. In an implementation, the actor interface engine 115 allows the actor to redeem good currency for goods or services at a redeemer. In an implementation, the valuation of good currency for a transaction such as a redemption, trade, etc. is based on a present valuation of good currency, as determined by the good currency management engine 130 at the time of the transaction.

In an implementation, the actor interface engine 115 provides an actor with a list of the actor's past charitable actions that were used to obtain good currency. The actor interface engine 115 may also provide redeemers, peers, or others with the list of past charitable actions. Such a list of past charitable actions are discussed further in the context of the good currency management engine 130.

In the example of FIG. 1, the redeemer interface engine 120 is coupled to the computer-readable medium 105. The redeemer interface engine 120 may include an “engine” and a “datastore,” as described in this paper. In a specific implementation, the redeemer interface engine 120 interfaces with redeemers. The redeemer interface engine 120 may include a standalone application for a computer, a mobile application for a mobile device, or may be implemented as a web portal or a part of a web page displayed on a redeemer's device. In some implementations, the redeemer interface engine 120 may be incorporated into a redeemer's point of sale (POS) device. In a specific implementation, the redeemer interface engine 120 may be managed by the good currency management engine 130 as discussed further in this paper, though it is noted that one or more of the functionalities described herein may be incorporated in the redeemer interface engine 120 itself.

In a specific implementation, the redeemer interface engine 120 facilitates redemption of good currency. More specifically, the redeemer interface engine 120 may provide an actor or a peer of an actor with good, services, benefits, etc. in exchange for good currency. The redeemer interface engine 120 may also take actions based on the actor's list of past charitable actions. For instance, the redeemer interface engine 120 may provide an actor with goods, services, benefits, etc. for the actor's list of past charitable actions without actually using any of the actor's good currency. In an implementation, the valuation of good currency for a transaction such as a redemption, trade, etc. is based on a present valuation of good currency, as determined by the good currency management engine 130 at the time of the transaction.

In the example of FIG. 1, the peer user interface engine 125 is coupled to the computer-readable medium 105. The peer user interface engine 125 may include an “engine” and a “datastore,” as described in this paper. In a specific implementation, the peer user interface engine 125 interfaces with peers of an actor. The peer user interface engine 125 may be configured similarly to the actor interface engine 115 but need not receive notifications of charitable actions. That is, the peer user interface engine 125 may be configured to facilitate exchange of good currency without any input about a peer's charitable actions. It is noted the peer user interface engine 125 and the actor interface engine 115 may be freely interchangeable in various implementations.

In the example of FIG. 1, the good currency management engine 130 is coupled to the computer-readable medium 105. The good currency management engine 130 may include an “engine” and a “datastore,” as described in this paper. The good currency management engine 130 may be implemented as a set of networked applications on one or more servers. The networked applications may serve the needs of the donor interface engine 110, the actor interface engine 115, the redeemer interface engine 120, and the peer user interface engine 125.

In a specific implementation, the good currency management engine 130 manages the donor interface engine 110. More specifically, the good currency management engine 130 may manage how donations are received and incorporated into good currency.

In a particular implementation, the good currency management engine 130 manages the actor interface engine 115 and/or the peer user interface engine 125. In some implementations, the good currency management engine 130 receives notifications of charitable actions performed by an actor associated with the actor interface engine 115. In an implementation, the good currency management engine 130 further determines a goodness magnitude, such as a number representing the value of the charitable actions. The goodness magnitude may correspond to a quantified moral value of the charitable actions. A quantified moral value, as used herein, may refer to monetary value assigned to one or more charitable actions. In various implementations, the good currency management engine 130 assigns an amount of good currency to the actor from the reserve based on a goodness magnitude of charitable actions. In some implementations, the good currency management engine 130 allows the actor to manage the good currency the actor has assigned to it. The good currency management engine 130 may further manage trades of good currency performed by the actor and/or the actor's peers.

In a specific implementation, the good currency management engine 130 manages the redeemer interface engine 120. In some implementations, the good currency management engine 130 may facilitate redemption of good currency for at least portions of goods, services, and/or benefits. The good currency management engine 130 may also manage a redeemer's good currency redemption account. In various implementations, the good currency management engine 130 manages a redeemer's profile.

In various implementations, the good currency management engine 130 manages a good currency exchange. In some implementations, the good currency management engine 130 manages the supply of good currency available for circulation. Moreover, the good currency management engine 130 may also manage the total amount of good currency to be stored in a reserve. As various implementations involve using donations to back amounts of good currency in reserve, the good currency management engine 130 may manage the worth of the good currency in reserve. In some implementations, the good currency management engine 130 provides a present valuation of good currency based on various factors, such as the amount of good currency in reserve, the amount of good currency in circulation, and other factors.

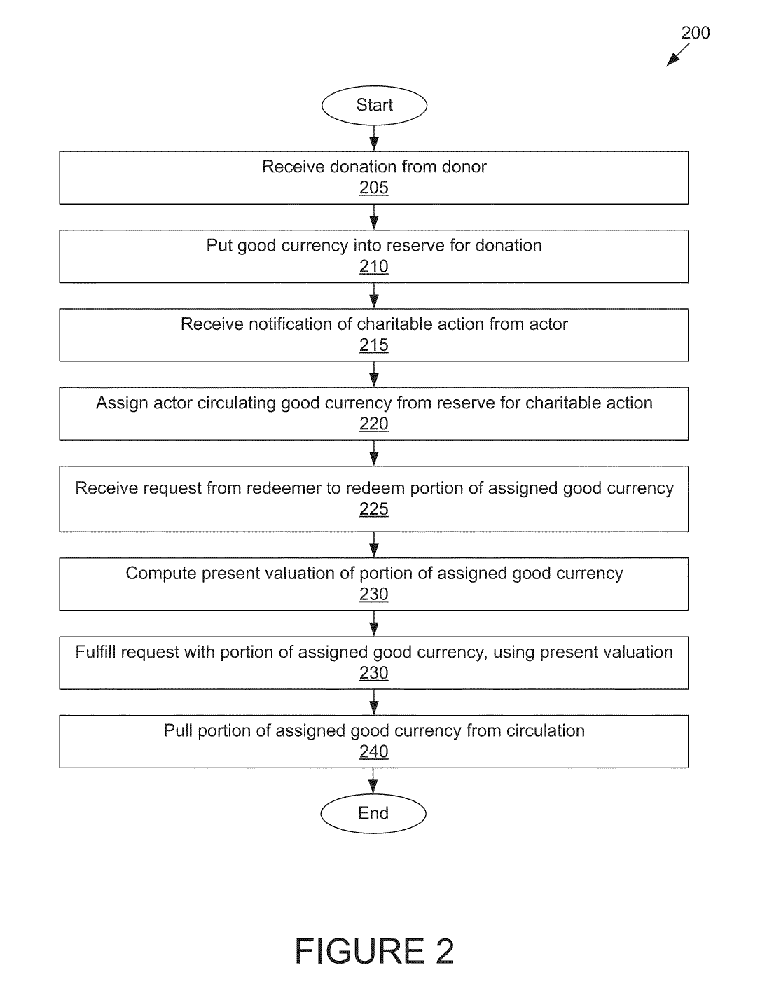

FIG. 2 depicts a flowchart of an example of a method 200 for facilitating exchange of good currency, in accordance with some implementations. The method 200 is discussed in conjunction with the structures shown in FIG. 1. It is noted various implementations of the method 200 may involve greater or fewer blocks than expressly illustrated in FIG. 2.

At block 205, a donation is received from a donor. In a specific implementation, the donor interface engine 110 may receive a donation from a donor. The donation may be received through the application, web portal, or web page implemented by the donor interface engine 110. The donation may take any convenient form, including money, an amount of credit, or a tangible or intangible asset, for instance. The donation may involve varying amounts. The donation may also include a one-time donation or a donation structured to be provided over a period of time (e.g., in installments).

At block 210, good currency is put into reserve for the donation. In a specific implementation, the good currency management engine 130 may put good currency into reserve for the donation. More specifically, the good currency management engine 130 may quantify the donation and may create a corresponding amount of good currency in reserve. The amount of the good currency may correspond to the amount of the donation. Each item of good currency created in the reserve may have one or more of the properties of good currency, as described herein. Further, each item of good currency in the reserve may be tagged with the information about the donor, in varying implementations.

At block 215, a notification of a charitable action is received from an actor. In a specific implementation, the actor interface engine 115 may receive a notification of a charitable action. For instance, the actor interface engine 115 may receive, through its application, web portal, web page, etc., that an actor planted a tree, gave blood, helped a stranger, gave money to someone, etc. The actor interface engine 115 may provide the notification of the good deed to the good currency management engine 130.

At block 220, circulating good currency is assigned from the reserve to the actor for the charitable action. In an implementation, the good currency management engine 130 may assign the actor associated with the actor interface engine 115 circulating good currency for the charitable action. The amount assigned to the actor may be based on a “goodness magnitude” of the charitable action. In an implementation, the good currency management engine 130 may determine the goodness magnitude of the charitable action based on factors such as the distance of the beneficiary of the charitable action and the burden to the actor. The good currency management engine 130 may also base the amount assigned on the amount of good currency in circulation at the time of the charitable action. For instance, if there were more good currency in circulation at the time of the charitable action, the good currency management engine 130 may assign less good currency to the actor for the charitable action; conversely, if there were less good currency in circulation at the time of the charitable action, the good currency management engine 130 may assign more to the actor for the charitable action.

At block 225, a request to redeem a portion of the assigned good currency is received from a redeemer. In a specific implementation, the redeemer interface engine 120 receives a request to redeem a portion of assigned good currency. The redeemer interface engine 120 may have, in turn, received the request to redeem the portion of the assigned good currency from the actor interface engine 115, or from the peer user interface engine 125. The redeemer interface engine 120 may provide the request to redeem the portion of the assigned good currency to the good currency management engine 130. As discussed, the redeemer interface engine 120 may be in the process of facilitating a transaction using the assigned good currency. The good currency management engine 130 may verify the validity of the portion of good currency by checking that it properly belongs to the correct actor, was not stolen, was not corrupted, and is indeed a valid item of good currency.

At block 230, the present valuation of the portion of the good currency is computed. In a specific implementation, the good currency management engine 130 computes the present valuation of the portion of the good currency. In some implementations, the good currency management engine 130 may evaluate how much good currency is in circulation and how much good currency is backed by donations in the reserve. Based on these and other factors, the good currency management engine 130 may determine good currency supply, demand, and other factors to provide a present valuation of the good currency at the time of the redemption.

At block 235, the request is fulfilled with the portion of the good currency using the present valuation. In an implementation, the redeemer interface engine 120 may receive a notification that the portion of the assigned good currency has been verified. The redeemer interface engine 120 may further apply the portion of the good currency toward a portion of a good, service, or benefit for the actor. The amount applied may depend on the present valuation of good currency, as determined at block 230. At block 240, the portion of the assigned good currency is pulled from circulation. In an implementation, the good currency management engine 130 returns an amount equivalent to the portion of the assigned good currency to reserve. The method 200 may then complete.

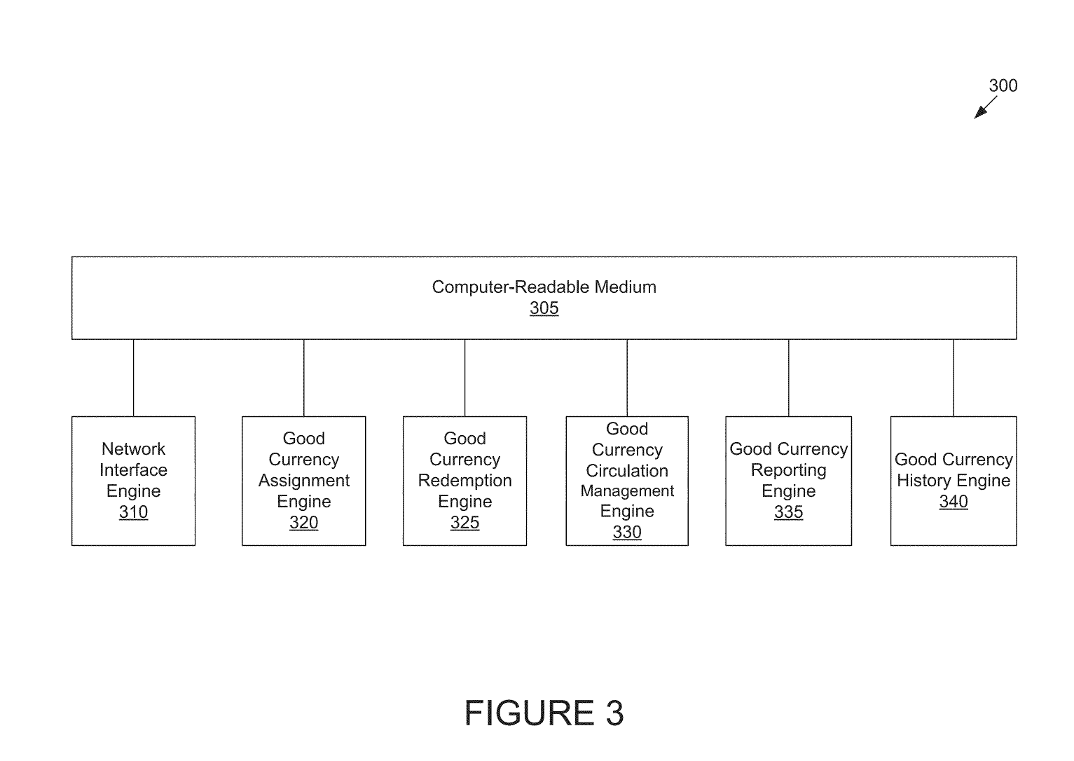

FIG. 3 depicts a diagram illustrating an example of a good currency management engine 300, in accordance with some implementations. In the example of FIG. 3, the good currency management engine 300 includes a computer-readable medium 305, a network interface engine 310, a good currency assignment engine 320, a good currency redemption engine 325, a good currency circulation management engine 330, a good currency reporting engine 335, and a good currency history engine 340. One or more of the network interface engine 310, the good currency assignment engine 320, the good currency redemption engine 325, the good currency circulation management engine 330, the good currency reporting engine 335, and the good currency history engine 340 may include an “engine,” as described herein.

In the example of FIG. 3, the computer-readable medium 305 is coupled to the network interface engine 310, the donor management engine 315, the good currency assignment engine 320, the good currency redemption engine 325, the good currency circulation management engine 330, the good currency reporting engine 335, and the good currency history engine 340. In a specific implementation, the computer-readable medium 305 may comprise a “computer-readable medium,” as described in this paper.

In the example of FIG. the network interface engine 310 is coupled to the computer-readable medium 305. In a specific implementation, the network interface engine 310 interfaces with a network, e.g., a network implemented by the computer-readable medium 105 in FIG. 1. The network interface engine 310 may transmit and receive data between the network and the other engines of the good currency management engine 300, in various implementations.

In the example of FIG. 3, the good currency assignment engine 320 is coupled to the computer-readable medium 305. In an implementation, the good currency assignment engine 320 assigns good currency for charitable actions. The good currency assignment engine 320 may record charitable actions, may verify the authenticity of the charitable actions, may measure the goodness magnitude of charitable actions, and may determine amounts of good currency to assign based on the goodness magnitude of those charitable actions. The good currency assignment engine 320 may also assign good currency in other ways without departing from the scope and substance of the inventive concepts described in this paper.

In the example of FIG. 3, the good currency redemption engine 325 is coupled to the computer-readable medium 305. In a specific implementation, the good currency redemption engine 325 allows an actor to redeem good currency assigned to the actor. More specifically, the good currency redemption engine 325 may receive information about a transaction and may provide assigned good currency to a redeemer interface engine (e.g., the redeemer interface engine 120 in FIG. 1) for the transaction. In various implementations, the good currency redemption engine 325 bases the redemption on a real-time valuation of good currency computed at the time of the transaction.

In the example of FIG. 3, the good currency circulation management engine 330 is coupled to the computer-readable medium 305. In a specific implementation, the good currency circulation management engine 330 manages the circulation of good currency. More specifically, in some implementations, the good currency circulation management engine 330 manages donations of good currency, manages entry of donations into good currency reserve, manages which how much good currency is allowed into circulation, manages tracking of good currency transactions across the good currency exchange, and manages how good currency should be valued. In some implementations, the good currency circulation management engine 330 releases good currency into circulation. Good currency released into circulation may have identifying information, including an identifier of the actor who performed a charitable action for the good currency to be released, a time and/or date of the release, and a tracking identifier for the good currency to be tracked as it passes to peers and/or redeemers.

In the example of FIG. 3, the good currency reporting engine 335 is coupled to the computer-readable medium 305. In a specific implementation, the good currency reporting engine 335 provides reports of how particular actors, particular peers, and/or particular redeemers used good currency.

In the example of FIG. 3, the good currency history engine 340 is coupled to the computer-readable medium 305. In a specific implementation, the good currency history engine 340 provides an actor with a history of charitable actions the actor has performed. In some implementations, the good currency history engine 340 may include one or more datastores, as discussed in this paper, to maintain relevant histories for relevant actors. The good currency history engine 340 may also maintain an actor's history of redeeming good currency. In some implementations, the good currency history engine 340 may track the actor's actions in other ways.

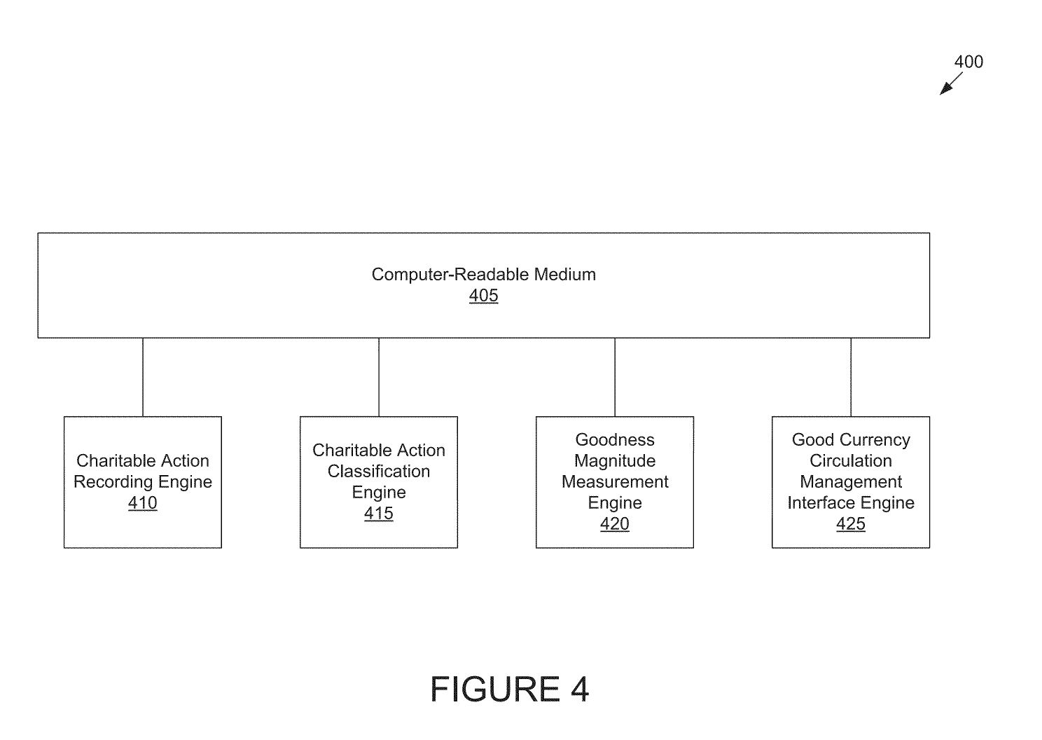

FIG. 4 depicts a diagram illustrating an example of a good currency assignment engine 400, in accordance with some implementations. In the example of FIG. 4, the good currency assignment engine 400 may include a computer-readable medium 405, a charitable action reporting engine 410, a charitable action classification engine 415, a goodness magnitude measurement engine 420, and a good currency circulation management interface engine 425.

In the example of FIG. 4, the computer-readable medium 405 is coupled to the charitable action reporting engine 410, the charitable action classification engine 415, the goodness magnitude measurement engine 420, and the good currency circulation management interface engine 425. In a specific implementation, the computer-readable medium 405 may comprise a “computer-readable medium,” as described in this paper.

In the example of FIG. 4, the charitable action reporting engine 410 is coupled to the computer-readable medium 405. In an implementation, the charitable action reporting engine 410 receives notifications of charitable actions performed by the actor. In some implementations, the notifications may comprise data about a charitable action the actor has entered into an actor interface engine. The notifications may also comprise data entered by a charitable actions application managed by a third-party. Examples of such third-party applications include applications managing donations of blood, organs, etc.; applications verifying charitable actions were performed (e.g., applications verifying trees were planted, people were fed, money was donated); applications verifying an actor provided information to others (e.g., registered a pothole on a road in a map, noted something in a town was broken, reported a crime on an application, etc.); applications verifying a presentation of the actor was viewed by others (e.g., an application verifying views of an educational video posted by the actor, likes on a social networking sites posting information provided by the actor, etc.); applications verifying crowd funding (e.g., applications verifying the actor provided money to start-ups or to entities in developing countries). These examples are not exhaustive and are meant instead to illustrate the breadth of how the notifications of charitable actions may arrive at the charitable action reporting engine 410.

In the example of FIG. 4, the charitable action classification engine 415 is coupled to the computer-readable medium 405. In an implementation, the charitable action classification engine 415 classifies and verifies the charitable actions performed by the actor. In some implementations, the charitable action classification engine 415 may review the nature of the charitable action to ensure it was indeed charitable. That is, the charitable action classification engine 415 may determine whether the actor benefited from the charitable action, and if so, whether the benefit to the actor should be deducted from the charitable value of the charitable act. For instance, if the actor invested in a start-up in exchange for equity in the start-up, the charitable action classification engine 415 may determine that the investment action was not charitable because the actor received a substantial benefit as a result of the investment action.

In the example of FIG. 4, the goodness magnitude measurement engine 420 is coupled to the computer-readable medium 405. In an implementation, the goodness magnitude measurement engine 420 provides a goodness magnitude for charitable actions. Examples of factors that can be used include how distant the beneficiary of the charitable action was from the actor (e.g., whether the beneficiary was a direct relative, a friend, a neighbor, a stranger, etc.), and further include the burden to the actor (e.g., whether the charitable action involved less burden like giving a small amount of money, or a larger burden like giving blood or an organ). It is noted the goodness magnitude measurement engine 420 may measure the goodness magnitude of charitable actions in other ways without departing from the scope and substance of the inventive concepts described in this paper.

In the example of FIG. 4, the good currency circulation management interface engine 425 is coupled to the computer-readable medium 405. In an implementation, the good currency circulation management interface engine 425 interfaces with a good currency circulation management engine (e.g., the good currency circulation management engine 330 shown in FIG. 3).

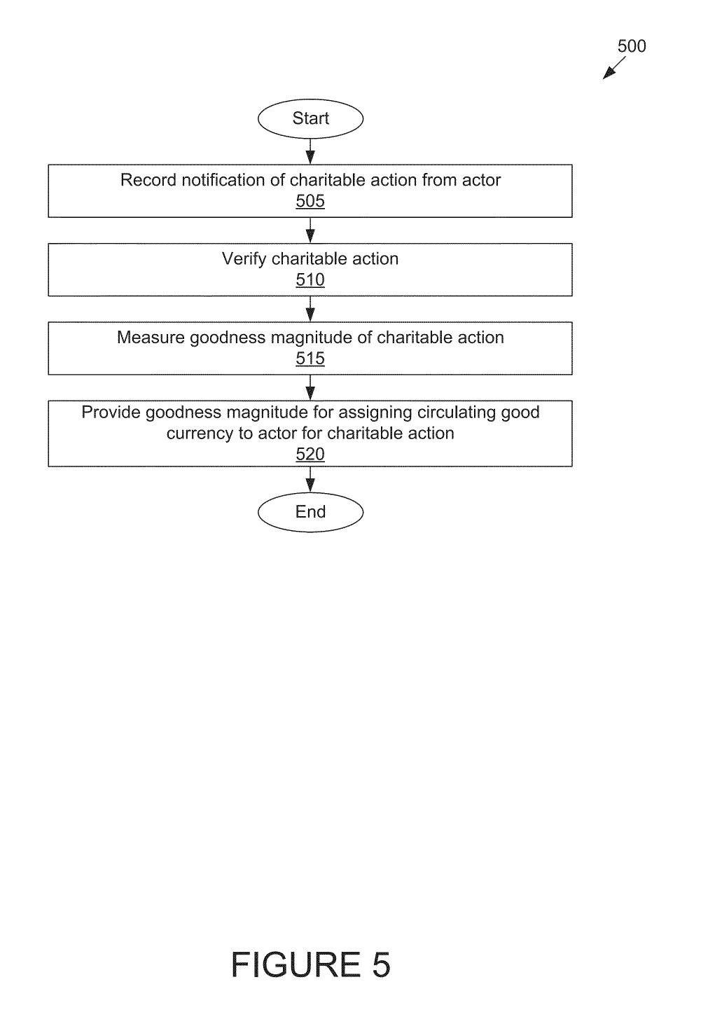

FIG. 5 depicts a flowchart of an example of a method 500 for assigning good currency for a good deed, in accordance with some implementations. The method 500 is discussed in conjunction with the structures shown in FIG. 4. It is noted various implementations of the method 500 may involve greater or fewer blocks than expressly illustrated in FIG. 5.

At block 505, a notification of a charitable action is received from an actor. In a specific implementation, the charitable action reporting engine 410 may receive a notification of a charitable action from an actor.

At block 510, the charitable action is verified. In an implementation, the charitable action classification engine 415 may verify the charitable action. The charitable action classification engine 415 may verify whether the actor of the charitable action is sufficiently disinterested or distant from the charitable action. The charitable action classification engine 415 may also verify whether any benefits the actor received as a result of the charitable action would preclude the action from being verified as charitable.

At block 515, the goodness magnitude of the charitable action is measured. In an implementation, the goodness magnitude measurement engine 420 measures the goodness magnitude of the charitable action. The goodness magnitude measurement engine 420 may measure attributes of the charitable action such as distance from the actor, burden to the actor, and other factors.

At block 520, the goodness magnitude is provided for assigning circulating good currency to the actor for the charitable action. In an implementation, the good currency circulation management interface engine 425 provides the goodness magnitude for assigning circulating good currency to the actor for the charitable action.

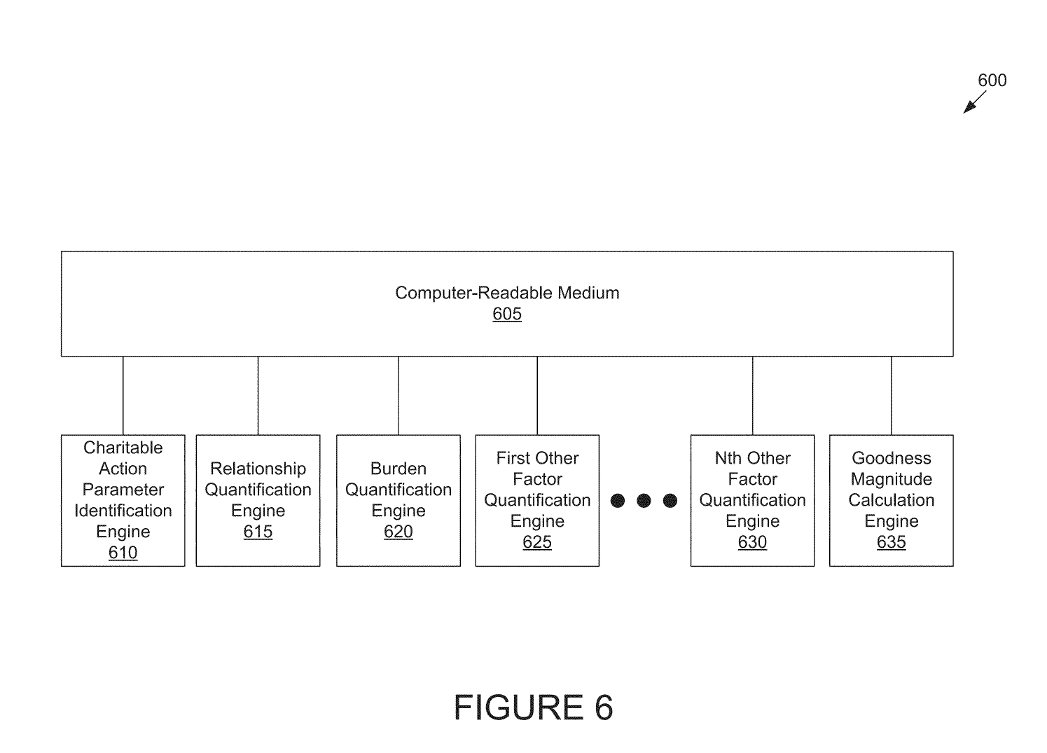

FIG. 6 depicts a diagram illustrating an example of a goodness magnitude measurement engine 600, in accordance with some implementations. In the example of FIG. 6, the goodness magnitude measurement engine 600 engine includes a computer-readable medium 605, a charitable action parameter identification engine 610, a relationship quantification engine 615, a burden quantification engine 620, a first other factor quantification engine 625, an Nth other factor quantification engine 630, and a goodness magnitude calculation engine 635.

In the example of FIG. 6 the computer-readable medium 605 is coupled to the charitable action parameter identification engine 610, the relationship quantification engine 615, the burden quantification engine 620, the first other factor quantification engine 625, the Nth other factor quantification engine 630, and the goodness magnitude calculation engine 635. In a specific implementation, the computer-readable medium 605 comprises a “computer-readable medium,” as described in this paper.

In the example of FIG. 6, the charitable action parameter identification engine 610 is coupled to the computer-readable medium 605. In an implementation, the charitable action parameter identification engine 610 extracts goodness parameters of a charitable action. More specifically, in an implementation, the charitable action parameter identification engine 610 extracts the actor associated with a charitable action, the beneficiary (e.g., the person, place, or thing) that receives the benefit of the charitable action, and other factors (e.g., factors related to the morality of a charitable action) that may be relevant to assigning a goodness magnitude to the charitable action. The charitable action parameter identification engine 610 may provide the goodness parameters to the other modules of the goodness magnitude measurement engine 600.

In the example of FIG. 6, the relationship quantification engine 615 is coupled to the computer-readable medium 605. In an implementation, the relationship quantification engine 615 quantifies a relationship between an actor and the beneficiary of a charitable action by the actor. In some implementations, the relationship quantification engine 615 may determine whether the charitable action falls into one of several predefined classes of relationships between actors and others in general. For instance, the relationship quantification engine 615 may determine whether the actor and the beneficiary are: the same entity, family and/or friends, acquaintances, members of a common community, or are complete strangers. The relationship quantification engine 615 may further assign a relationship score that quantifies how distant a beneficiary of a charitable action is from an actor.

In the example of FIG. 6, the burden quantification engine 620 is coupled to the computer-readable medium 605. In an implementation, the burden quantification engine 620 quantifies a burden the charitable action places on the actor. In various implementations, the burden quantification engine 620 determines whether the charitable action falls within one of several predefined classes of burdens known to exist for actors. For instance, the burden quantification engine 620 may determine whether the charitable action is an investment of money in exchange for consideration, an act of charity, an expense of time and energy, or a donation of a body part (e.g., blood or organs). The burden quantification engine 620 may further assign a burden score that quantifies the burden of the charitable act on the actor.

In the example of FIG. 6, the first other factor quantification engine 625 is coupled to the computer-readable medium 605. In an implementation, the first other factor quantification engine 625 quantifies a first other factor associated with the charitable action. In the example of FIG. 6, the Nth other factor quantification engine 630 is coupled to the computer-readable medium 605. In an implementation, the Nth other factor quantification engine 630 quantifies an Nth other factor associated with the charitable action.

In the example of FIG. 6, the goodness magnitude calculation engine 635 is coupled to the computer-readable medium 605. In an implementation, the goodness magnitude calculation engine 635 provides a goodness magnitude of the charitable action. In various implementations, the goodness magnitude is some combination of the relationship score, the burden score, and one or more of the quantified other factors of the charitable action. In some implementations, the goodness magnitude weights one or more of the relationship score, the burden score, and one or more of the quantified other factors appropriately.

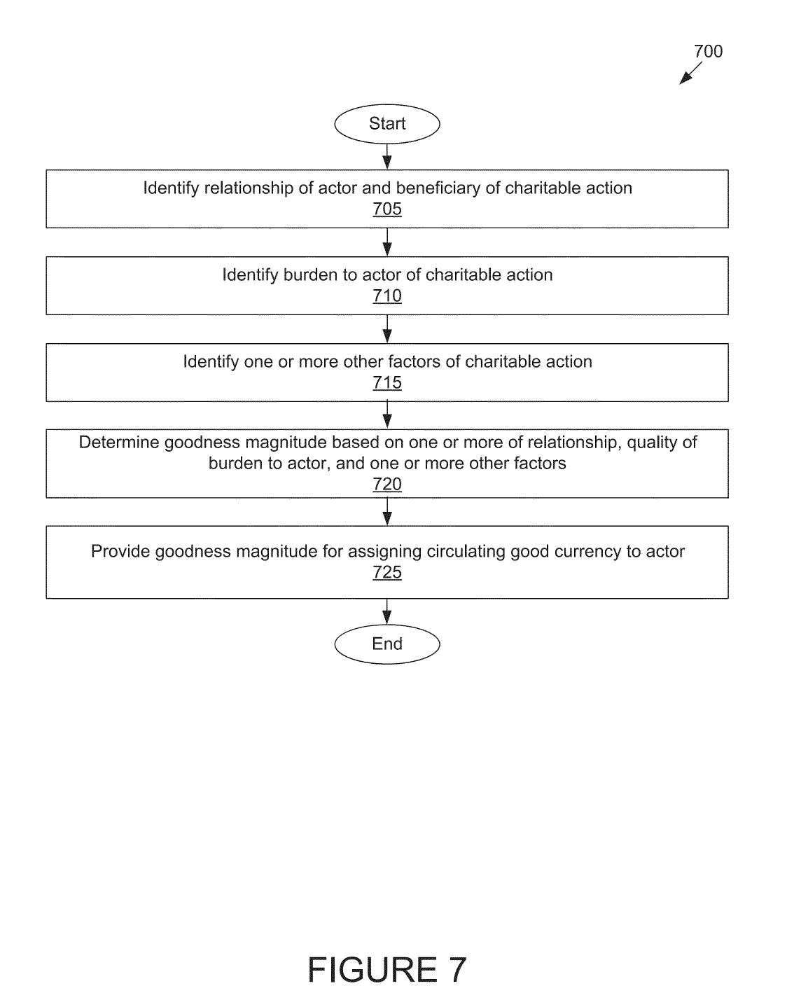

FIG. 7 depicts a flowchart of an example of a method 700 for measuring a goodness magnitude of a good deed, in accordance with some implementations. The method 700 is discussed in conjunction with the structures shown in FIG. 6. It is noted various implementations of the method 700 may involve greater or fewer blocks than expressly illustrated in FIG. 7.

At block 705, a relationship of the actor and a beneficiary of a charitable action performed by the actor is identified. In an implementation, the relationship quantification engine 615 identifies a relationship of the actor and a beneficiary of a charitable action performed by the actor. In some implementations, the relationship quantification engine 615 may base the relationship on information supplied by the actor when the actor was performing the charitable action. In various implementations, the relationship quantification engine 615 may base the relationship on information supplied by third-parties other than the actor. In some implementations, the relationship quantification engine 615 determines whether the actor and the beneficiary fall into one of several classes of known relationships, such as: the same entity, family and/or friends, acquaintances, members of a common community, or are complete strangers. In an implementation, the relationship quantification engine 615 assigns a relationship score to the charitable action depending on the relationship distance of the actor and beneficiary. Though a single beneficiary and relationship are discussed, it is noted multiple relationships and relationship scores may exist for a single charitable action.

At block 710, a burden to the actor due to the charitable action is identified. In an implementation, the burden quantification engine 620 identifies a burden to the actor due to the charitable action. In some implementations, the burden quantification engine 620 may base the burden on information supplied by the actor, while in some implementations, the burden quantification engine 620 may base the burden on information verified by third-parties. In some implementations, the burden quantification engine 620 determines whether the charitable action falls into one of several predetermined categories of burdens, such as: an investment of money in exchange for consideration, an act of charity, an expense of time and energy, or a donation of a body part (e.g., blood or organs). In an implementation, the burden quantification engine 620 assigns a burden score to the charitable action depending on the nature of the burden. Though a single burden is discussed, it is noted multiple burdens and burden scores may exist for a single charitable action.

At block 715, one or more other factors of the charitable action are identified. In some implementations, the first other factor quantification engine 625 through the Nth other factor quantification engine 630 determines other parameters that would help quantify the moral value of the charitable action. The first other factor quantification engine 625 through the Nth other factor quantification engine 630 may further assign other factor scores to the charitable action depending on the applicability of the other factors.

At block 720, the goodness magnitude of the charitable action is assigned based on one or more of the relationship, the burden, and the one or more other factors. In some implementations, the goodness magnitude calculation engine 635 combines relevant scores, such as relationship scores, burden scores, and other factor scores. The goodness magnitude calculation engine 635 may weight relationships, burdens, and other factors appropriately. At block 725, the goodness magnitude is provided for assigning circulating good currency to the actor. In an implementation, the goodness magnitude calculation engine 635 provides the goodness magnitude for assigning circulating good currency to the actor.

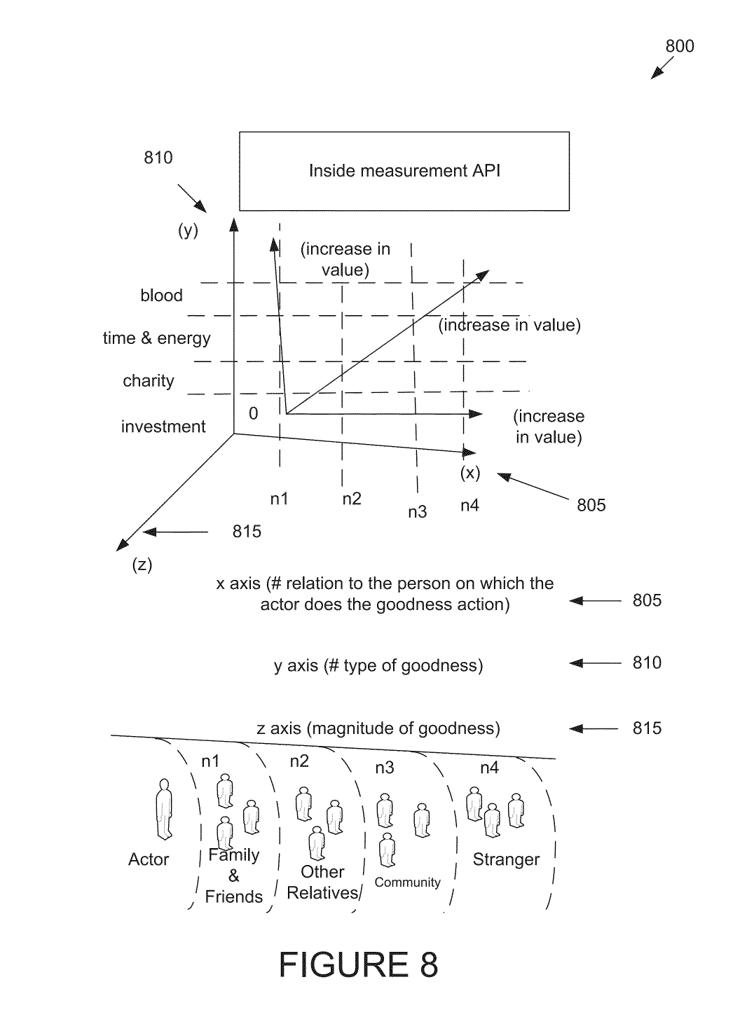

FIG. 8 depicts a screen 800 of an example of implementing a goodness magnitude calculation, in accordance with some implementations. In the example of FIG. 8, the screen 800 includes a first axis 805, a second axis 810, and a third axis 815. In a specific implementation, the first axis 805 may represent a relationship between an actor and a beneficiary of a charitable action. In this implementation, the first axis 805 may be segmented into four categories (n1, n2, n3, and n4). The first category, n1, may represent friends and family of the actor. The second category n2 may represent acquaintances. The third category n3 may represent community. The fourth category n4 may represent complete strangers. The greater the value of a charitable action on the first axis 805, the greater the relationship score for that charitable action. Though FIG. 8 depicts the goodness magnitude calculation as being based on a fixed number (i.e., four) categories, it is noted that in various implementations, the goodness magnitude may be based on more or less than four categories. Further, the goodness magnitude calculation need not be based on a fixed number of categories, but rather can be based on a number of categories that are dynamically determined and based on a use case. Further, the goodness magnitude calculation may also depend, in some implementations, on the degree(s) of separation between an actor and a recipient.

In a specific implementation, the second axis 810 may represent a burden of a charitable action on the actor. In this implementation, the second axis 810 is segmented into four categories: investment, charity, time & energy, and blood. The greater the value of a charitable action on the second axis 810, the greater the burden score for that charitable action. In an implementation, the third axis 815 represents the vector magnitude of the relationship score and the burden score. In this example, the value of the third axis 815 may be used to represent the goodness magnitude of a charitable action.

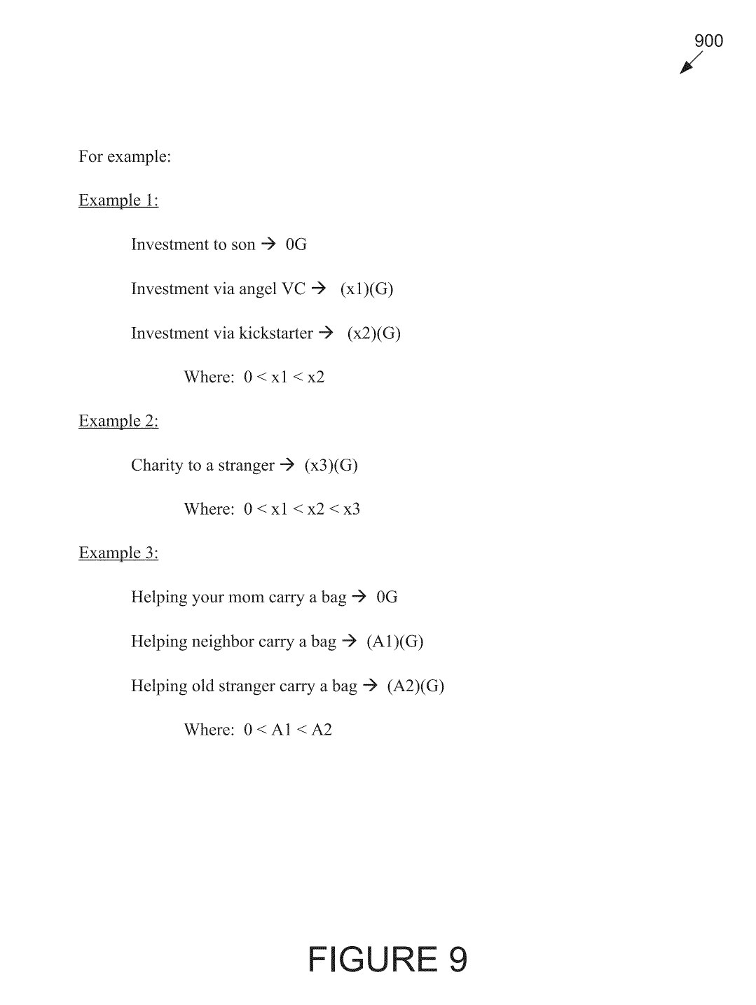

FIG. 9 depicts a screen 900 of an example of a goodness magnitude calculation, in accordance with some implementations. In the first example, an investment via a crowd funding website would carry a greater goodness magnitude than an investment via an angel fund, which in turn may carry more goodness magnitude than an investment to a son. In the second example, charity to a stranger may carry more goodness magnitude than any type of investment. In the third example, helping a person carry a bag may carry more goodness magnitude if the person is not related to the actor. In an implementation, the goodness magnitude calculation engine 635 may employ one or more of the logical rules illustrated in FIG. 9.

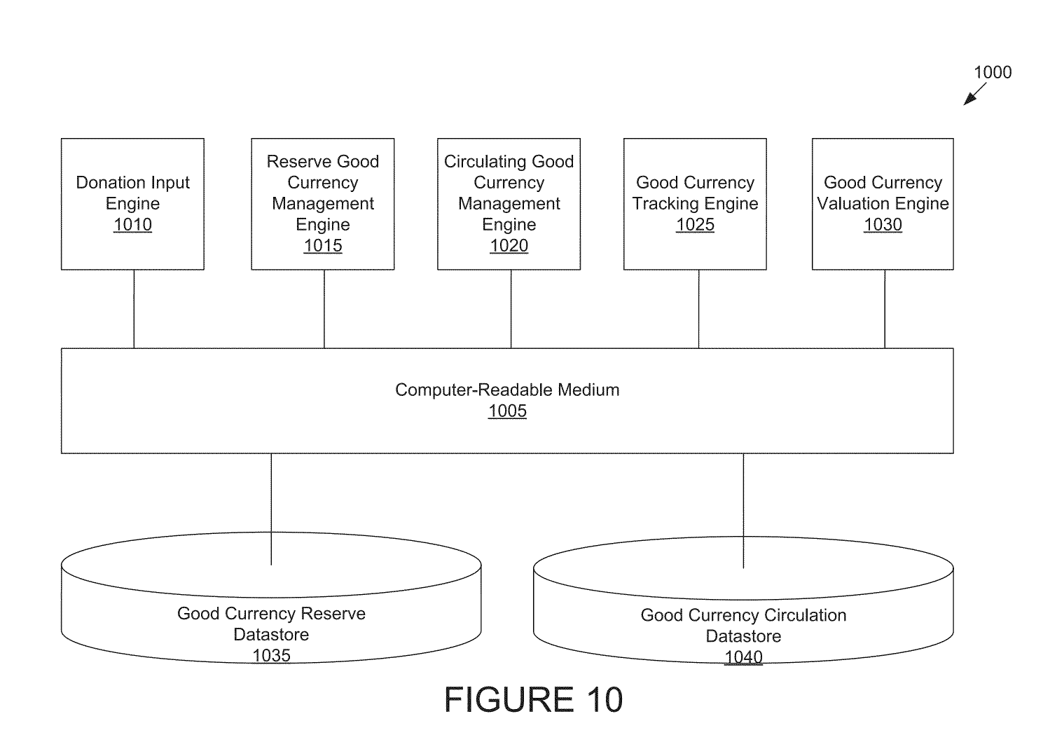

FIG. 10 depicts a diagram illustrating an example of a good currency circulation management engine 1000, in accordance with some implementations. In the example of FIG. 10, the good currency circulation management engine 1000 includes a computer-readable medium 1005, a donation input engine 1010, a reserve good currency management engine 1015, a circulating good currency management engine 1020, a good currency tracking engine 1025, a good currency valuation engine 1030, a good currency reserve datastore 1035, and a good currency circulation datastore 1040. One or more of the computer-readable medium 1005, the donation input engine 1010, the reserve good currency management engine 1015, the circulating good currency management engine 1020, the good currency tracking engine 1025, and the good currency valuation engine 1030 may include an “engine,” as described in this paper. One or more of the good currency reserve datastore 1035 and the good currency circulation datastore 1040 may include a “datastore,” as described in this paper.

In the example of FIG. 10, the computer-readable medium 1005 is coupled to the computer-readable medium 1005, the donation input engine 1010, the reserve good currency management engine 1015, the circulating good currency management engine 1020, the good currency tracking engine 1025, the good currency valuation engine 1030, the good currency reserve datastore 1035, and the good currency circulation datastore 1040. In a particular implementation, the computer-readable medium 1005 comprises a “computer-readable medium,” as described in this paper.

In the example of FIG. 10, the donation input engine 1010 is coupled to the computer-readable medium 1005. In a specific implementation, the donation input engine 1010 receives donations from a donor. The donation input engine 1010 may also quantify monetary amounts for those donations. In an implementation, the donation input engine 1010 may quantify the donations into a monetary amount. Once a donation is quantified, the donation input engine 1010 may place the donated amount into the good currency reserve datastore 1035 to provide good currency, as discussed further in this paper. The donation input engine 1010 may further maintain interfaces with banks, financial institutions, etc. as needed to ensure donations are validly reconciled with external financial systems.

In the example of FIG. 10, the reserve good currency management engine 1015 is coupled to the computer-readable medium 1005. In an implementation, the reserve good currency management engine 1015 manages the good currency reserve datastore 1035; i.e., manages good currency reserves. The reserve good currency management engine 1015 may add good currency to the good currency reserve datastore 1035 based on donations. The reserve good currency management engine 1015 may also release good currency from the good currency reserve datastore 1035 to the good currency circulation datastore 1040 for circulation. The reserve good currency management engine 1015 may further ensure the good currency reserve datastore 1035 is adequately secured.

In the example of FIG. 10, the circulating good currency management engine 1020 is coupled to the computer-readable medium 1005. In various implementations, the circulating good currency management engine 1020 manages the good currency circulation datastore 1040; i.e., manages good currency in circulation. The circulating good currency management engine 1020 may provide instructions to the reserve good currency management engine 1015 to release good currency into circulation. In an implementation, when good currency is released into circulation, the good currency may be released with one or more identifiers, including an actor identifier of an actor who performed a charitable action for the good currency to be released, a time and/or date of the release, and a tracking identifier of the good currency. In some implementations, the circulating good currency management engine 1020 updates circulating good currency based on a present valuation of the good currency from the good currency valuation engine 1030.

In the example of FIG. 10, the good currency tracking engine 1025 is coupled to the computer-readable medium 1005. In an implementation, the good currency tracking engine 1025 tracks good currency as it circulates. For instance, the good currency tracking engine 1025 may track good currency as it passes between actors, peers, and redeemers.

In the example of FIG. 10, the good currency valuation engine 1030 is coupled to the computer-readable medium 1005. In a specific implementation, the good currency valuation engine 1030 provides an accurate valuation of good currency in the good currency reserve datastore 1035 based on the amount of donations that have been provided. In a sense, the good currency valuation engine 1030 can estimate the supply of good currency based on donations provided. In various implementations, the good currency valuation engine 1030 may also determine valuation of good currency in circulation (i.e., in the good currency circulation datastore 1040) based on how many charitable actions actors have performed. In a sense, the good currency valuation engine 1030 can estimate the demand for good currency based on how many charitable actions have been performed and how good currency is circulating.

In the example of FIG. 10, the good currency reserve datastore 1035 is coupled to the computer-readable medium 1005. In an implementation, the good currency reserve datastore 1035 stores good currency in reserve. In the example of FIG. 10, the good currency circulation datastore 1040 is coupled to the computer-readable medium 1005. In an implementation, the good currency circulation datastore 1040 stores good currency in circulation.

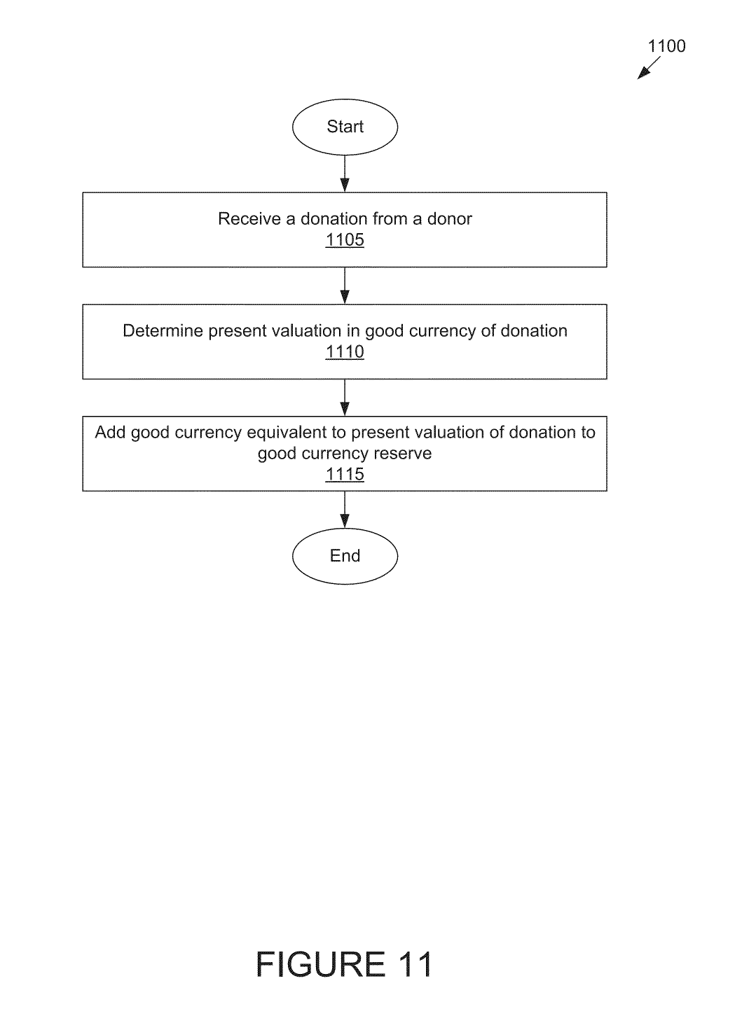

FIG. 11 depicts a flowchart of an example of a method 1100 for creating good currency based on a donation, in accordance with some implementations. The method 1100 is discussed in conjunction with the structures shown in FIG. 10. It is noted various implementations of the method 1100 may involve greater or fewer blocks than expressly illustrated in FIG. 11.

At block 1105, a donation from a donor is received. In a specific implementation, the donation input engine 1010 may receive a donation from a donor. At block 1110, present valuation in good currency of the donation is determined. In a specific implementation, the good currency valuation engine 1030 may determine how much good currency is present in both the good currency reserve datastore 1035 and the good currency circulation datastore 1040. Based on these values, the good currency valuation engine 1030 may determine a present valuation of the donation in good currency. At block 1115, good currency equivalent to the present valuation of the donation is added to the good currency reserve. In an implementation, the reserve good currency management engine 1015 may add good currency equivalent to the present valuation of the donation to the good currency reserve datastore 1035.

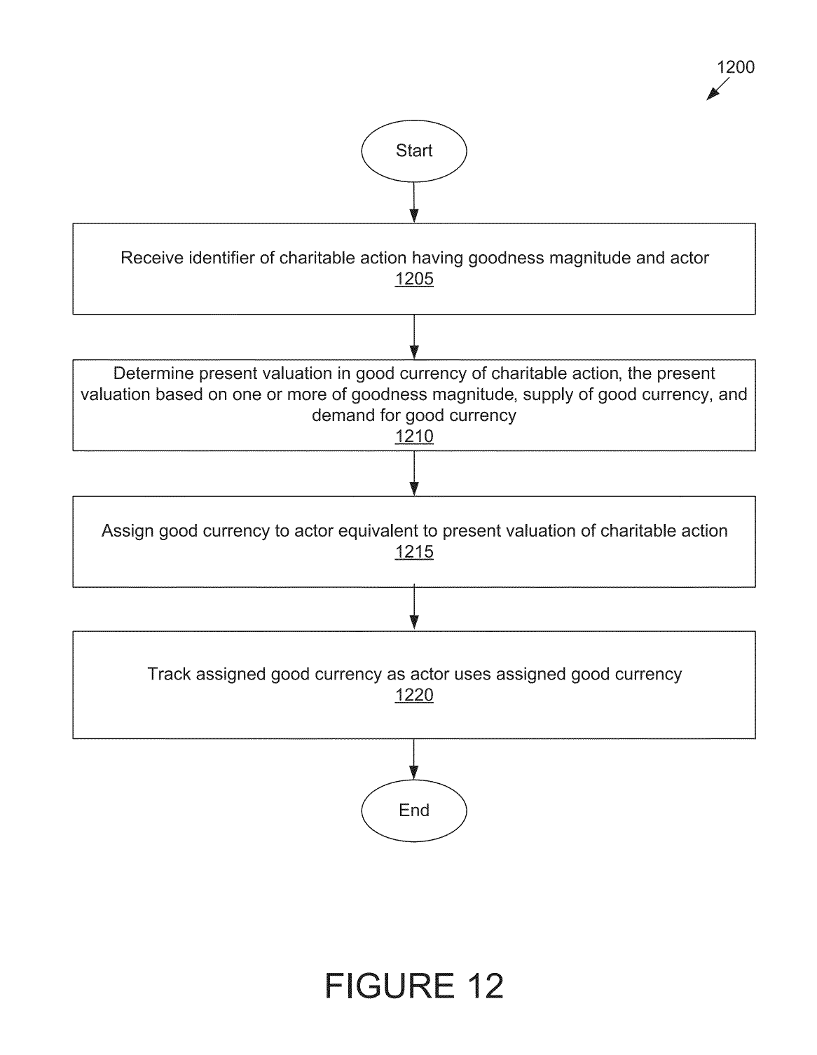

FIG. 12 depicts a flowchart of an example of a method for assigning good currency for a good deed, in accordance with some implementations. The method 1200 is discussed in conjunction with the structures shown in FIG. 10. It is noted various implementations of the method 1200 may involve greater or fewer blocks than expressly illustrated in FIG. 12.

At block 1205, an identifier of a charitable action is received, the charitable action having a goodness magnitude and an actor. In a particular implementation, the circulating good currency management engine 1020 may receive an identifier of a charitable action with the goodness magnitude and the actor.

At block 1210, a present valuation in good currency of the charitable action is determined. The present valuation of the charitable action is based on one or more of the goodness magnitude, the supply of good currency, and demand for good currency. In some implementations, the good currency valuation engine 1030 may determine the present valuation of the charitable action. The present valuation may be based on any of the factors discussed in this paper, including the goodness magnitude of the charitable action, the supply of good currency, and the demand for good currency

At block 1215, good currency equivalent to the present valuation of the charitable action is assigned to the actor. In an implementation, the circulating good currency management engine 1020 may assign good currency equivalent to the present valuation of the charitable action. In an implementation, assigning the good currency may involve assigning an actor identifier of an actor who performed a charitable action for the good currency to be released, a time and/or date of the release, or a tracking identifier of the good currency.

At block 1220, the assigned good currency is tracked as the actor uses the assigned good currency. In an implementation, the good currency tracking engine 1025 may track the assigned good currency as the actor uses the assigned good currency.

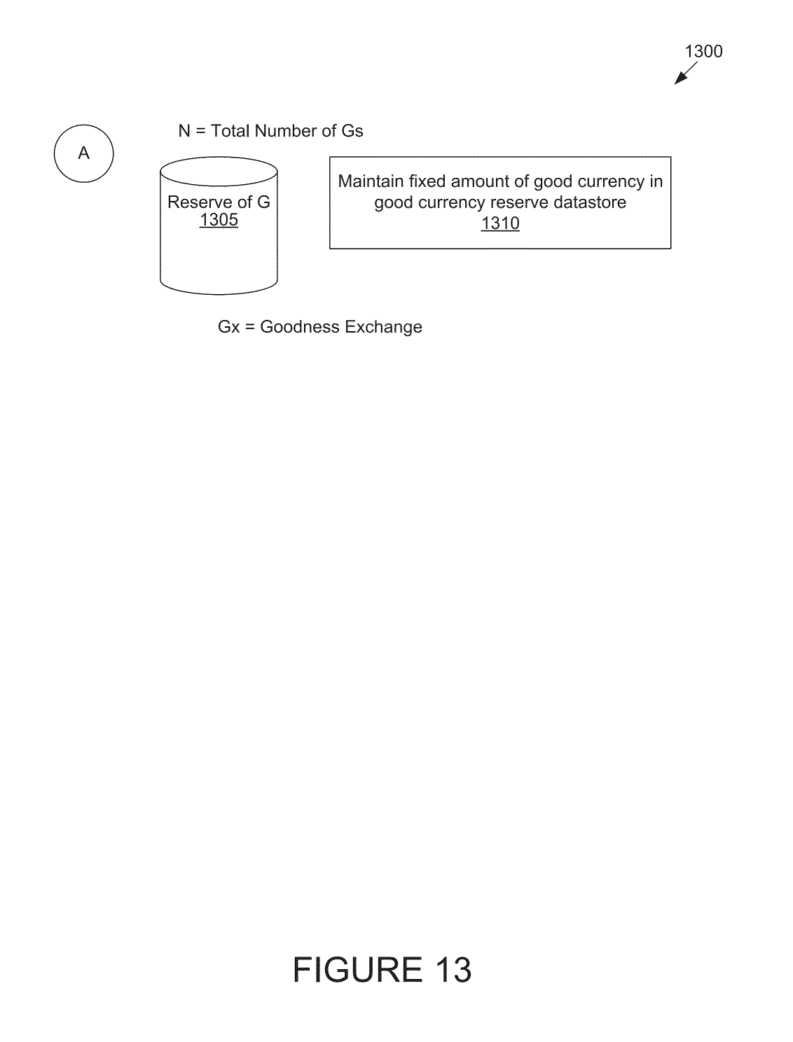

FIG. 13 depicts an example of a screen 1300 of maintaining a goodness reserve, in accordance with some implementations. In the example of FIG. 13, the screen 1300 shows a good currency reserve datastore 1305. In a specific implementation, the good currency reserve datastore 1305 may correspond to the good currency reserve datastore 1035 (shown in FIG. 10). Moreover, the good currency reserve datastore 1305 may maintain a reserve of good currency, as discussed in this paper. In the example of FIG. 13, the screen 1300 includes a transaction block 1310, maintaining a fixed amount of good currency in the good currency reserve datastore 1305. More specifically, the good currency reserve datastore 1305 has a fixed amount of good currency, designated by the number “N,” stored within. The fixed amount of good currency may depend, at least in part, on the amount of charitable contributions provided to a good currency management engine (e.g., the good currency management engine 130 shown in FIG. 1), containing the good currency reserve datastore 1305. The fixed amount of good currency within the good currency reserve datastore 1305 may have a valuation, as determined by the good currency valuation engine 1030, shown in FIG. 10.

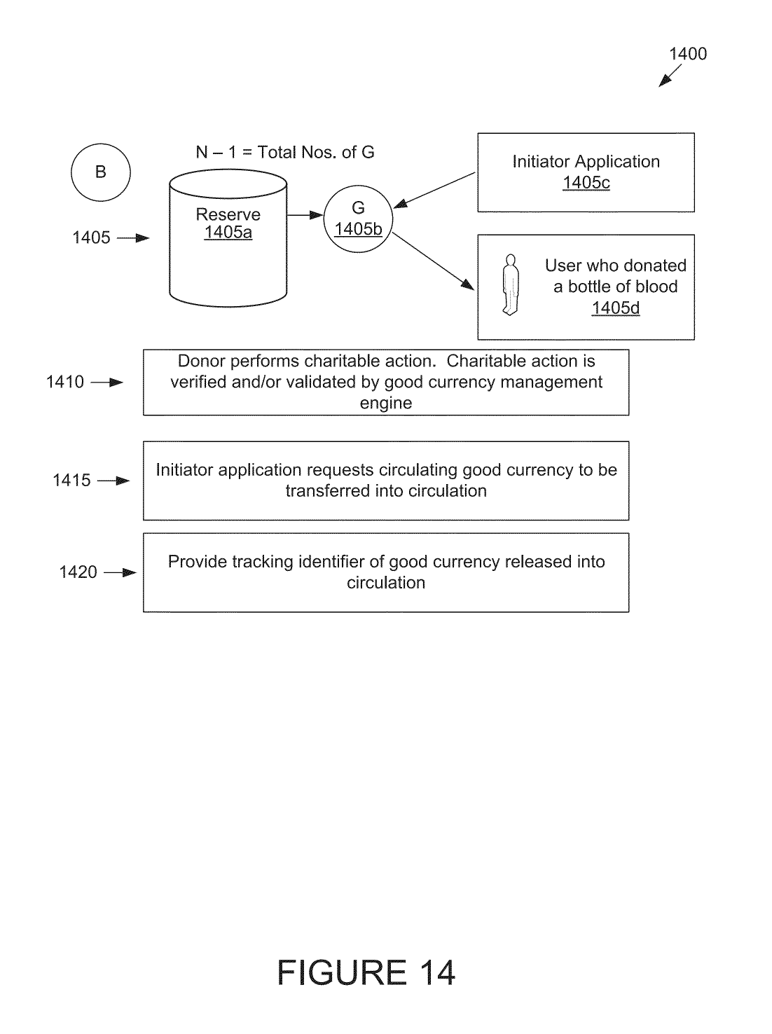

FIG. 14 depicts an example of a screen 1400 for assigning good currency for a charitable action, in accordance with some implementations. In the example of FIG. 14, the screen 1400 shows a good currency transaction environment 1405. In the example of FIG. 14, the good currency transaction environment 1405 includes a good currency reserve datastore 1405a, circulating good currency 1405b, an initiator application 1405c, and a donor 1405d. In a specific implementation, the good currency reserve datastore 1405a may correspond to the good currency reserve datastore 1035, shown in FIG. 10. The circulating good currency 1405b may correspond to items of circulating good currency, i.e., the good currency stored in the good currency circulation datastore 1040, shown in FIG. 10. The initiator application 1405c may correspond to an application associated with the donor interface engine 110, shown in FIG. 1. Further, the donor 1405d may correspond a person associated with the donor interface engine 110, shown in FIG. 1.

In the example of FIG. 14, the screen 1400 includes a first transaction block 1410, a second transaction block 1415, a third transaction block 1420, and a fourth transaction block 1425. In a specific implementation, the first transaction block 1410, the second transaction block 1415, and the third transaction block 1420 may correspond to blocks of a process performed within the elements of the good currency transaction environment 1405.

At the first transaction block 1410, the donor 1405d performs a charitable action, such as donating a bottle of blood. In an implementation, the initiator application 1405c verifies and/or validates the charitable action of the donor 1405d.

At the second transaction block 1415, the initiator application 1405c requests the circulating good currency 1405b to be transferred out of the good currency reserve datastore 1405a and into circulation. At this point, in circulation is the amount of good currency designated for the charitable action, which in this example can comprise one element of good currency. Also at this point, in the good currency reserve datastore 1405a is the fixed amount of good currency (“N”) minus the amount designated for the charitable action (i.e., “N−1” good currency remains in the good currency reserve datastore 1405a).

At the third transaction block 1420, there is provided a tracking identifier assigned to the good currency released into circulation. The tracking identifier may include any known or convenient format. In this example, the tracking identifier “01AXBOUEN” is provided for tracking the good currency that was released into circulation as a result of the charitable action of the donor 1405d.

In a specific implementation, the screen 1400 may depict what happens when a donor performs a charitable action. More specifically, the donor perform a charitable action, and may have good currency assigned into circulation. A tracking identifier may be assigned for the good currency in circulation.

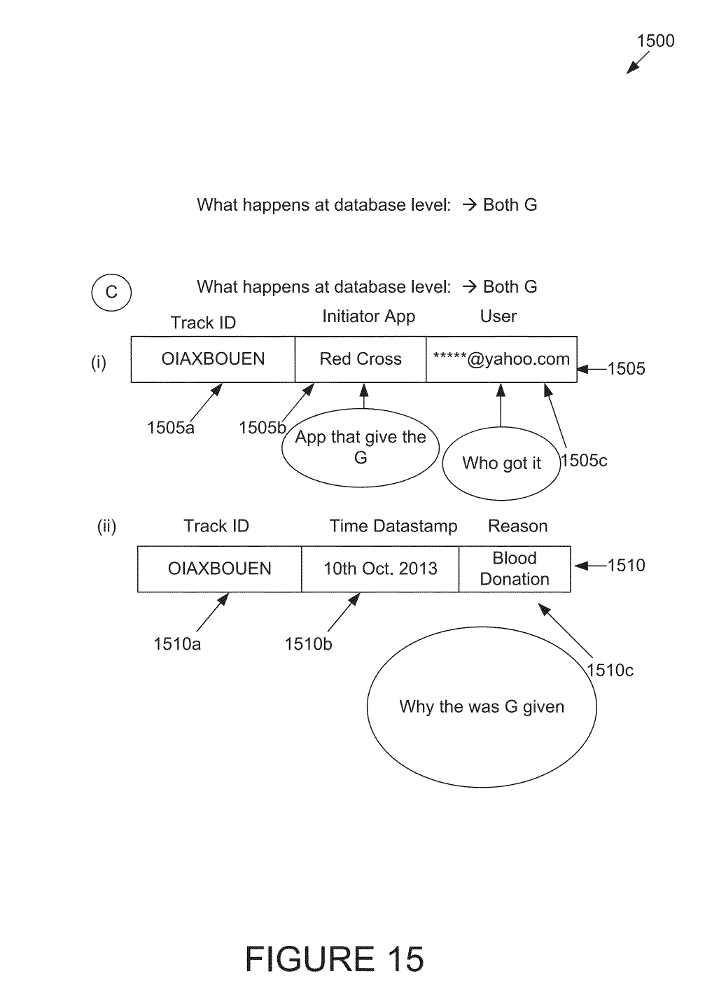

FIG. 15 depicts an example of a screen 1500 for assigning good currency for a good deed, in accordance with some implementations. In the example of FIG. 15, the screen 1500 includes a first transaction block 1505 and a second transaction block 1510. At the first transaction block 1505, attributes of the charitable action are appended to a data structure that represents the good currency in circulation. In this example, there is appended a first attribute 1505a that represents the tracking identifier of the good currency in circulation. There is also appended a second attribute 1505b that represents the initiator application (here “Red Cross”) that caused the good currency in circulation to leave the good currency reserve datastore. There is further appended a third attribute 1505c that represents a unique user identifier (here an email address) of the donor.

At the second transaction block 1510, attributes of the charitable action are appended to a data structure that represents the good currency in circulation. In this example, there is appended a first attribute 1510a that represents the tracking identifier of the good currency in circulation. There is also appended a second attribute 1505b that represents the time and date of the charitable action. There is further appended a third attribute 1510c that represents the reason the good currency in circulation was allowed to be in circulation or was given to the donor. It is noted that any of the information provided in the first transaction block 1505 and the second transaction block 1510 can be appended for a single charitable action, depending on the implementation.

In an implementation, the screen 1500 may depict what happens at the database level after the third transaction block 1420, shown in FIG. 14. In a specific implementation, the screen 1500 may depict what happens after the tracking identifier of the charitable action has been created and good currency has been assigned for circulation for the charitable action. More specifically, a data structure may be managed for the good currency in circulation. The data structure may include various ways to identify the good currency in circulation and/or link the charitable action to the good currency in circulation.

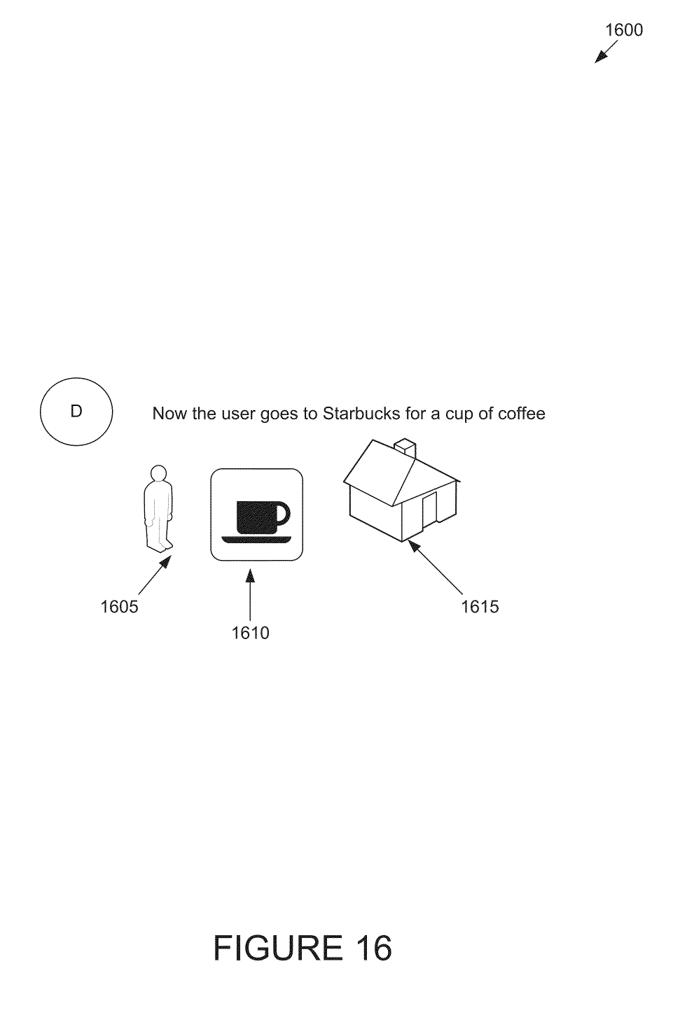

FIG. 16 depicts an example of a screen 1600 for redeeming good currency, in accordance with some implementations. In the example of FIG. 16, the screen 1600 includes an actor 1605, a purchasable item or service 1610, and a redeemer 1615. In various implementations, the actor 1605 may correspond to a person associated with the donor interface engine 110 (shown in FIG. 1) and the redeemer may correspond to an entity associated with the redeemer interface engine 120 (shown in FIG. 1). In other implementations, the actor 1605 may correspond to a person associated with the peer user interface engine 125 (shown in FIG. 1) and the redeemer may correspond to an entity associated with the redeemer interface engine 120 (shown in FIG. 1). In yet other implementations, the actor 1605 may correspond to a person associated with the donor interface engine 110 (shown in FIG. 1) and the redeemer may correspond to an entity associated with the peer user interface engine 125 (shown in FIG. 1). In other implementations, the actor 1605 and the redeemer may both correspond to instances of the peer user interface engine 125 (shown in FIG. 1).

In an implementation, the screen 1600 may depict what happens when the actor 1605 attempts to redeem the good currency in circulation. In this implementation, the actor 1605 may go to the redeemer 1615 to purchase the purchasable item or service 1610. The purchase may be based at least in part on redeeming good currency in circulation.

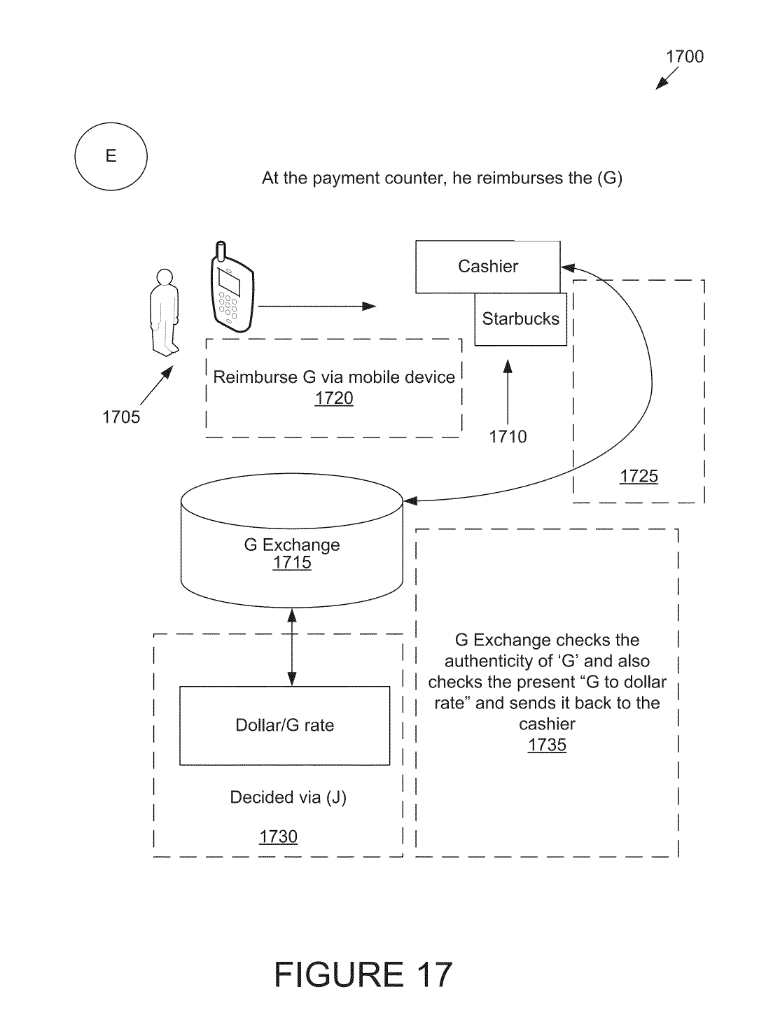

FIG. 17 depicts an example of a screen 1700 for redeeming good currency, in accordance with some implementations. In the example of FIG. 17, the screen 1700 includes an actor 1705, a redeemer 1710, and a good currency exchange 1715. In an implementation, the actor 1705 corresponds to a person associated with the donor interface engine 110 (shown in FIG. 1), while the redeemer 1710 corresponds to a person associated with the peer user interface engine 125 and/or an entity associated with the redeemer interface engine 120 (shown in FIG. 1). In other implementations, the actor 1705 corresponds to a first person associated with the peer user interface engine 125 (shown in FIG. 1), while the redeemer 1710 corresponds to a second person associated with the peer user interface engine 125 and/or an entity associated with the redeemer interface engine 120 (shown in FIG. 1). In various implementations, the good currency exchange 1715 corresponds to an entity associated with the good currency management engine 130 (shown in FIG. 1).

In the example of FIG. 17, the screen 1700 includes a first transaction block 1720, a second transaction block 1725, a third transaction block 1730, and a fourth transaction block 1735. At the first transaction block 1720, the actor 1705 seeks to redeem an amount of good currency in circulation using a mobile device associated with the actor 1705. At the second transaction block 1725, the redeemer 1710 provides information about the proposed redemption to the good currency exchange 1715. At the third transaction block 1730, the good currency exchange 1715 determines the valuation of good currency at the moment of the proposed redemption. At the fourth transaction block 1735, the good currency exchange 1715 checks the authenticity of the good currency in circulation of the actor 1705, and returns the present valuation of the good currency in circulation of the actor 1705 to the redeemer 1710.

In a specific implementation, the screen 1700 may depict what happens when the actor 1705 attempts to redeem the good currency in circulation from the redeemer 1710. In this implementation, good currency of the actor 1705 is provided to the redeemer 1710. The redeemer 1710 provides the good currency to the good currency exchange 1715. The good currency exchange 1715 determines the valuation of the good currency, and returns the valuation to the redeemer 1710.

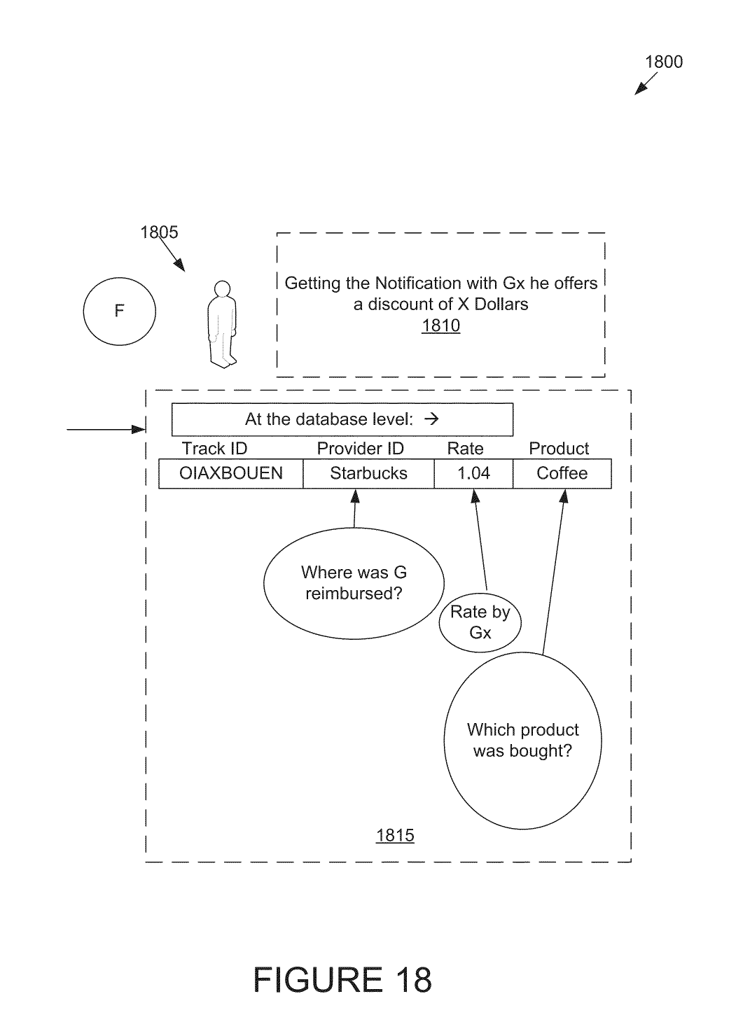

FIG. 18 depicts an example of a screen 1800 for redeeming good currency, in accordance with some implementations. In the example of FIG. 18, the screen 1800 includes a redeemer 1805. In a specific implementation, the redeemer 1805 corresponds to a person associated with the peer user interface engine 125 and/or an entity associated with the redeemer interface engine 120 (shown in FIG. 1).

In the example of FIG. 18, the screen 1800 includes a first transaction block 1810 and a second transaction block 1815. At the first transaction block 1810, the redeemer 1805 receives a notification of the present valuation of good currency an actor is attempting to redeem. The redeemer 1805 offers a discount consistent with this present valuation. At the second transaction block 1815, the redeemer 1805 updates the data structure of the good currency of the actor to reflect the discount. In an implementation, the screen 1800 may represent what happens when the redeemer 1805 is attempting to apply a discount based on the present valuation of the good currency to a product or service an actor is trying to use the good currency toward.

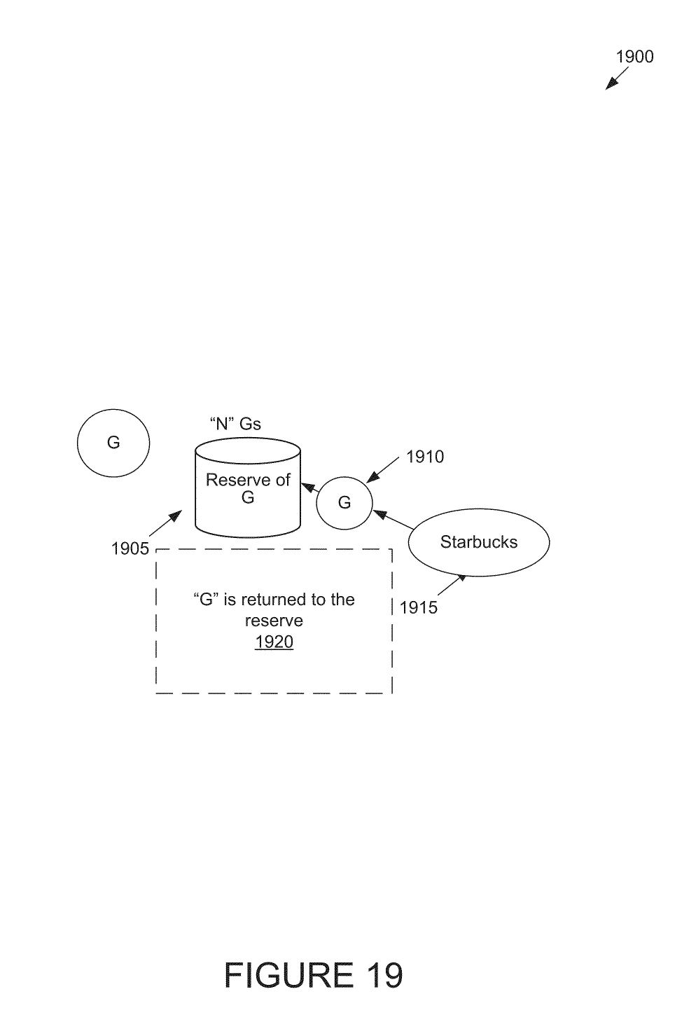

FIG. 19 depicts an example of a screen 1900 for redeeming good currency, in accordance with some implementations. In the example of FIG. 19, the screen 1900 includes a good currency reserve datastore 1905, a returning good currency amount 1910, and a redeemer 1915. In some implementations, the good currency reserve datastore 1905 corresponds to the good currency reserve datastore 1035, shown in FIG. 10. In an implementation, the redeemer 1915 corresponds to an entity associated with the redeemer interface engine 120, shown in FIG. 1. In the example of FIG. 19, the screen 1900 includes a transaction block 1920, where the returning good currency amount 1910 is returned from the redeemer 1915 to the good currency reserve datastore 1905.

In a specific implementation, the screen 1900 may depict what happens when a redeemer has used good currency toward a portion of a transaction. More specifically, when a redeemer has used good currency toward a portion of a transaction, the good currency returns to the good currency reserve datastore 1905.

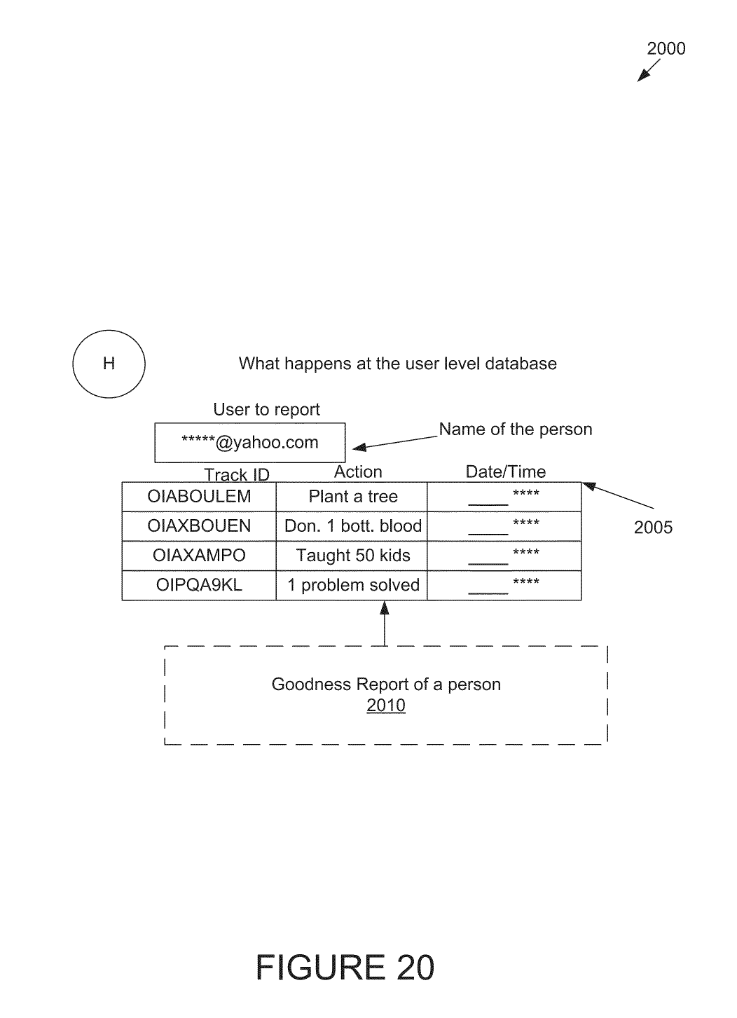

FIG. 20 depicts an example of a screen 2000 for generating a charitable actions report, in accordance with some implementations. In the example of FIG. 20, the screen 2000 includes a user report 2005 and a transaction block 2010. In a specific implementation, the user report 2005 may have been generated by good currency reporting engine 335 based on information from the good currency history engine 340, both shown in FIG. 3. In the example of FIG. 20, the transaction block 2010 comprises generating a charitable actions report for an actor. In an implementation, the screen 2000 may depict what happens when a charitable actions report is generated for a person. In this implementation, there is provided a verified list of charitable actions an actor has performed over a period of time. Also included are the tracking identifiers and/or the date and time of the charitable actions. In some implementations, the charitable actions report may be used as a personal and/or professional score sheet that depicts the actor's history of charitable actions. The score sheet may be used, in various implementations, for university admissions, hiring, online dating, etc. Further, in some embodiments, a charitable donations report (not shown in FIG. 20) may be provided for donor. Such a charitable donations report can depict every single event of goodness for which a donor's money is converted to good currency.

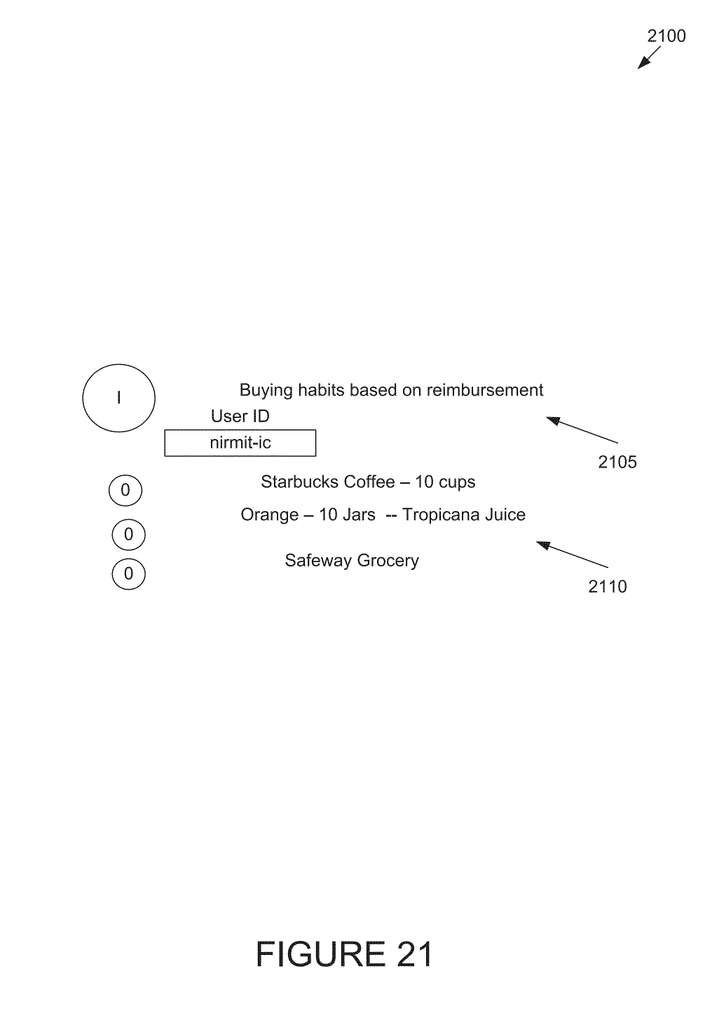

FIG. 21 depicts an example of a screen 2100 showing an actor's good currency redemption history, in accordance with some implementations. In the example of FIG. 21, the screen 2100 includes a list of buying habits 2105. In a specific implementation, the list of buying habits 2105 may include a history of how a particular actor has redeemed good currency in the past.

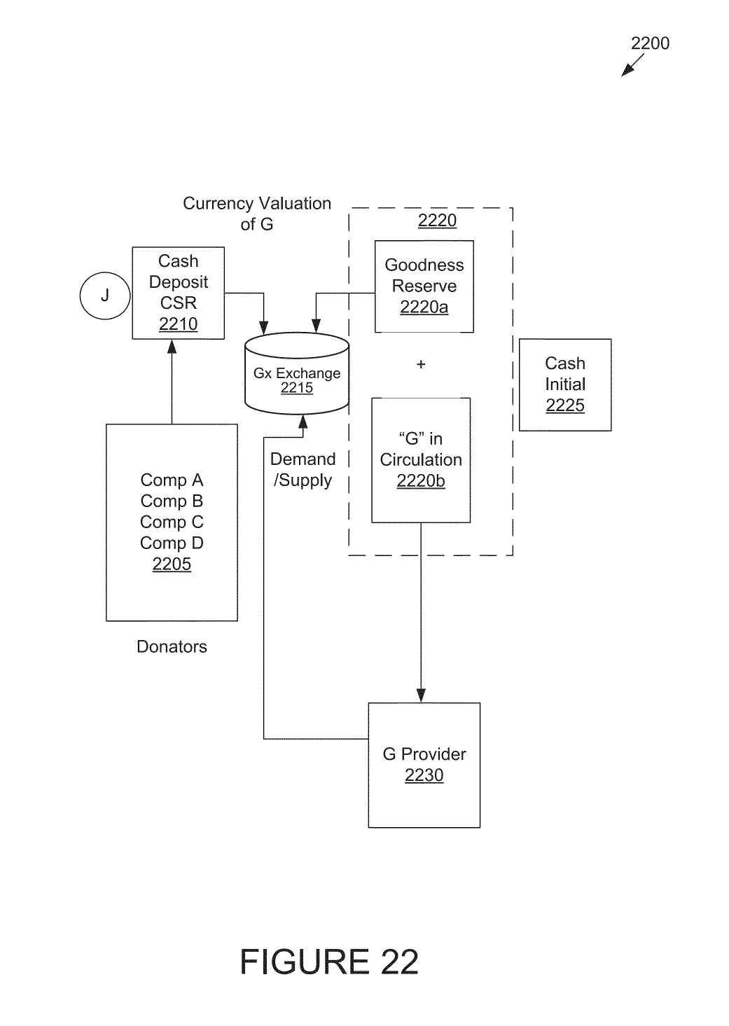

FIG. 22 depicts an example of a screen 2200 for valuing good currency, in accordance with some implementations. In the example of FIG. 22, the screen 2200 depicts donors 2205, donations 2210, a donation input engine 2215, a good currency datastore 2220 (which includes a good currency reserve datastore 2220a and a good currency circulation datastore 2220b), an assigned good currency amount 2225, and a redeemed good currency amount 2230. In an implementation, valuation of good currency can be based on the supply and demand of good currency. Supply of good currency may be determined by how much the donors 2205 input via the donations 2210 into the donation input engine 2215 and into the good currency reserve datastore 2220a. Demand may depend on how much of the assigned good currency amount 2225 and the redeemed good currency amount 2230 are in circulation and how much is to return to good currency datastores.

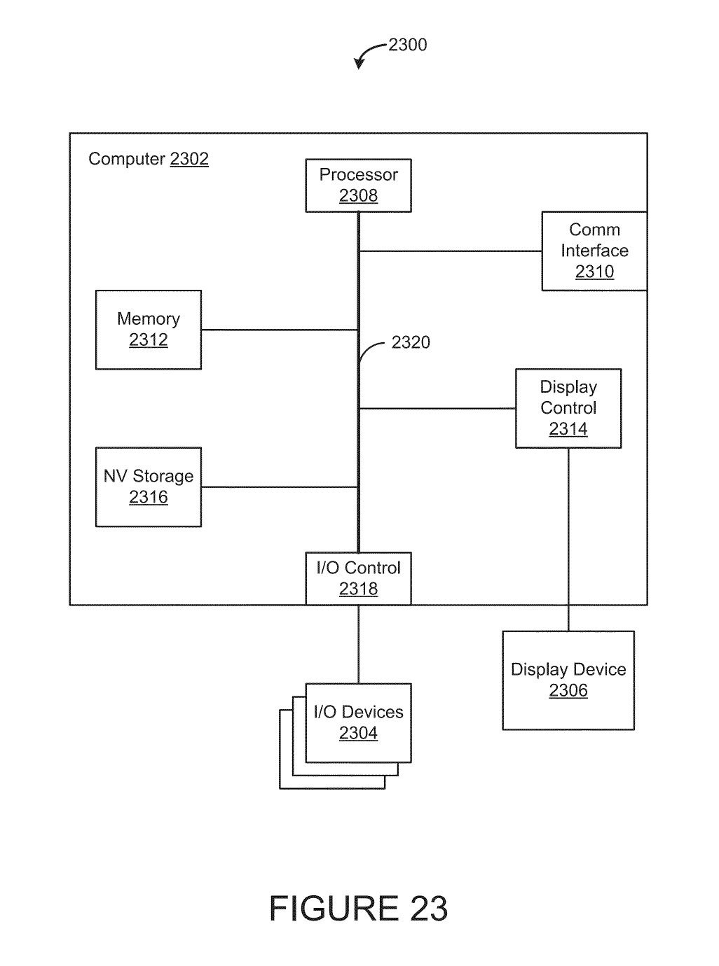

FIG. 23 shows an example of a computer system 2300 on which techniques described in this paper can be implemented. The computer system 2300 can be a conventional computer system that can be used as a client computer system, such as a wireless client or a workstation, or a server computer system. The computer system 2300 includes a computer 2305, I/O devices 2325, and a display device 2315. The computer 2305 includes a processor 2320, a communications interface 2325, memory 2330, display controller 2335, non-volatile storage 2340, and I/O controller 2345. The computer 2305 may be coupled to or include the I/O devices 2325 and display device 2315.

The computer 2305 interfaces to external systems through the communications interface 2325, which may include a modem or network interface. It will be appreciated that the communications interface 2325 can be considered to be part of the computer system 2300 or a part of the computer 2305. The communications interface 2325 can be an analog modem, ISDN modem, cable modem, token ring interface, satellite transmission interface (e.g. “direct PC”), or other interfaces for coupling a computer system to other computer systems.

The processor 2320 may be, for example, a conventional microprocessor such as an Intel Pentium microprocessor or Motorola power PC microprocessor. The memory 2330 is coupled to the processor 2320 by a bus 2320. The memory 2330 can be Dynamic Random Access Memory (DRAM) and can also include Static RAM (SRAM). The bus 2320 couples the processor 2320 to the memory 2330, also to the non-volatile storage 2340, to the display controller 2335, and to the I/O controller 2345.

The I/O devices 2325 can include a keyboard, disk drives, printers, a scanner, and other input and output devices, including a mouse or other pointing device. The display controller 2335 may control in the conventional manner a display on the display device 2315, which can be, for example, a cathode ray tube (CRT) or liquid crystal display (LCD). The display controller 2335 and the I/O controller 2345 can be implemented with conventional well-known technology.

The non-volatile storage 2340 is often a magnetic hard disk, an optical disk, or another form of storage for large amounts of data. Some of this data is often written, by a direct memory access process, into memory 2330 during execution of software in the computer 2305. One of skill in the art will immediately recognize that the terms “machine-readable medium” or “computer-readable medium” includes any type of storage device that is accessible by the processor 2320 and also encompasses a carrier wave that encodes a data signal.

The computer system 2300 is one example of many possible computer systems that have different architectures. For example, personal computers based on an Intel microprocessor often have multiple buses, one of which can be an I/O bus for the peripherals and one that directly connects the processor 2320 and the memory 2330 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 2330 for execution by the processor 2320. A Web TV system, which is known in the art, is also considered to be a computer system, but it may lack some of the features shown in FIG. 23, such as certain input or output devices. A typical computer system will usually include at least a processor, memory, and a bus coupling the memory to the processor.

Though FIG. 23 shows an example of the computer system 2300, it is noted that the term “computer system,” as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 23.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described in this paper, including clients, servers, and engines, can be compatible with or implemented using a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

This paper describes techniques that those of skill in the art can implement in numerous ways. For instance, those of skill in the art can implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using themes and based on a wide variety of amateur and professional content gathered from numerous sources. Although the foregoing implementations have been described in some detail for purposes of clarity of understanding, implementations are not necessarily limited to the details provided.

What is claimed is:

1. A method comprising:
receiving a notification of a charitable action, the charitable action to be performed by an actor;
measuring a goodness magnitude of the charitable action, the goodness magnitude providing a quantified moral value of the charitable action;
assigning the actor an amount of exchangeable currency, the amount being based on the measured goodness magnitude, the assigning being for the charitable action.

2. The method of claim 1, wherein the exchangeable currency is digital signed.

3. The method of claim 1, wherein the exchangeable currency is infinitely divisible.

4. The method of claim 1, wherein the exchangeable currency is divisible up to a fundamental level.

5. The method of claim 1, wherein the exchangeable currency is fungible with other exchangeable currency assigned for other charitable actions.

6. The method of claim 1, wherein the exchangeable currency is characterized by transactional irreversibility for all transactions involving the exchangeable currency.

7. The method of claim 1, wherein the exchangeable currency is backed at least in part by a donation from a donor.

8. The method of claim 1, wherein the goodness magnitude is based on one or more of: a relationship between the actor and a beneficiary of the charitable action, a burden the charitable action places on the actor, and other factors.

9. The method of claim 1, further comprising:
maintaining a reserve of the exchangeable currency;
providing the amount from the reserve.

10. The method of claim 1, wherein the charitable action is entered into one or more of: a mobile application, a website, and a standalone desktop application by the actor.

11. The method of claim 1, wherein the charitable action is entered into one or more of: a mobile application, a website, and a standalone desktop application by a third party other than the actor.

12. The method of claim 1, wherein facilitating exchange by the actor comprises:
receiving a request from a redeemer to redeem the exchangeable currency;
fulfilling the request with at least a portion of the assigned exchangeable currency.

13. The method of claim 12, wherein the redeemer comprises a peer of the actor.

14. The method of claim 12, further comprising computing a present valuation of the amount of exchangeable currency, and fulfilling the request using the present valuation.

15. The method of claim 14, wherein the present valuation is computed at one or more of: a time of receiving the request from the redeemer, and a time of sending the request to the redeemer.

16. The method of claim 14, wherein the present valuation is based at least in part on a total circulating amount of the exchangeable currency.

17. The method of claim 14, wherein the present valuation is based at least in part on a total reserve amount of the exchangeable currency.

18. The method of claim 12, wherein the redeemer has been sent the request from the actor.

19. The method of claim 10, wherein the exchangeable currency is characterized by transactional irreversibility for all transactions involving the exchangeable currency.

20. The method of claim 1, further comprising facilitating exchange by the actor of the exchangeable currency.

21. The method of claim 1, further comprising generating a goodness report containing at least the amount and an identifier of the actor.

22. A system comprising:
a charitable action recording engine;
a goodness magnitude measurement engine coupled to the charitable action recording engine;
a good currency assignment engine coupled to the goodness magnitude measurement engine; wherein, in operation:
the charitable action recording engine receives a notification of a charitable action, the charitable action to be performed by an actor;
the goodness magnitude measurement engine measures a goodness magnitude of the charitable action, the goodness magnitude providing a quantified moral value of the charitable action;
the good currency assignment engine assigns the actor an amount of exchangeable currency, the amount being based on the measured goodness magnitude, the assigning being for the charitable action.

23. A system comprising:
means for receiving a notification of a charitable action, the charitable action to be performed by an actor;
means for measuring a goodness magnitude of the charitable action, the goodness magnitude providing a quantified moral value of the charitable action;
means for assigning the actor an amount of exchangeable currency, the amount being based on the measured goodness magnitude, the assigning being for the charitable action.
